(19) United States
(12) Patent Application Publication
(10) Pub. No.: US 2024/0189824 A1
(43) Pub. Date: Jun. 13, 2024

(54) LIQUID HANDLING APPARATUS

(71) Applicant: Osler Diagnostics Limited, Oxford (GB)

(72) Inventors: Stuart MAY; Mark YEOMAN; Mark HYLAND; Richard LUXTON; Barry LILLIS

(21) Appl. No.: 18/553,189

(22) PCT Filed: Apr. 1, 2022
(86) PCT No.: PCT/EP2022/058804

§ 371 Date: Sep. 28, 2023

(30) Foreign Application Priority Data
Apr. 1, 2021 (GB) 2104784.0

(51) Int. Cl. B01L 3/00

(52) U.S. Cl. CPC B01L 3/523; B01L 2200/0684; B01L 2200/0689; B01L 2200/16; B01L 2300/044; B01L 2300/047; B01L 2300/0672; B01L 2300/0851; B01L 2400/0481; B01L 2400/0487

(57) ABSTRACT

Embodiments described herein relate to a liquid handling apparatus, comprising: a capsule configured to store a liquid reagent; a liquid handling device, comprising: a first conduit in fluidic communication with a first port; and a second conduit in fluidic communication with a second port; and a capsule interface mechanism configured to create: a first opening in the capsule in fluidic communication with the first port; and a second opening in the capsule in fluidic communication with the second port; wherein creating the first opening and the second opening allows the liquid reagent to be removed from the capsule.

### FIELD

The present disclosure relates to a liquid handling apparatus. In particular, the present disclosure relates to a liquid handling apparatus comprising a liquid handling device and a capsule configured to store a liquid reagent.

### BACKGROUND

Reagent storage capsules, such as blister capsules, are typically used in point-of-care diagnostic devices for storing liquid reagents used in specific diagnostic tests, such as immunoassays. The capsules are typically formed of a rigid vessel formed of a material that can be compressed in order to empty the capsule, and a film (e.g. a foil) that is used to seal the capsule once the vessel has been filled with the reagent(s). Sealed capsules can then be attached to the point-of-care diagnostic device using a layer of adhesive around the periphery of the sealing film.

To release liquid reagent from the capsule, a pressing or crushing force is typically applied to the rigid vessel, thereby compressing the rigid vessel and forcing the sealing film into contact with a piercing structure (e.g. a spike) within the device. The piercing structure is located beneath the capsule (assuming a force applied from above) and punctures a hole in the sealing film when sufficient force is applied. Continued pressing or crushing following puncture of the capsule forces the liquid reagent out of the hole in the capsule and into a fluidic layer of the device.

The reagent storage capsules used in existing devices cannot be completely filled with liquid reagent, because liquid within a completely-filled capsule would be displaced by a piercing structure, which would release the liquid within the capsule in an uncontrolled manner. In addition, it is not possible to seal a completely-filled capsule, because the liquid within the capsule would wet the sealing film and spread into the sealing areas, thereby preventing a proper seal from being formed. Accordingly, it is inevitable that reagent storage capsules include a quantity of air. The action of pressing or crushing the capsule to force out liquid reagent introduces air bubbles into the liquid reagent flow, which may interfere with the diagnostic test being conducted.

To mitigate this, some existing devices include a vented chamber to which the reagent is transferred once released from the capsule. The vented chamber allows air in the reagent to escape. The reagent is them moved out of the vented chamber for use in the diagnostic test. A disadvantage of this approach is that the vented chamber requires additional space in the device, thereby increasing the size of the liquid handling device.

In addition, the pressing or crushing action may be insufficient to fully release all of the liquid reagent from the capsule. In particular, the force required in order to release the liquid reagent may increase as the proportion of liquid within the capsule reduces. This means that a very high pressing or crushing force may be required in order to force the remaining reagent out of the capsule. The system used to process the point-of-care diagnostic device in order to carry out the diagnostic test may not be capable of applying such increased forces in order to fully release the liquid reagent. In addition, application of larger forces could cause the adhesive used to attach the capsules to the device to fail, resulting in liquid reagent being forced out through the join between the capsule and the device. The application of larger forces therefore has an impact on the selection of the adhesive material, meaning that adhesives with high adhesion strength to both the capsule foil and the cartridge material are required, which may lead to higher costs of the point-of-care diagnostic device.

Although one solution may be to use larger capsules so that only a proportion of the liquid reagent is required, such a solution would result in increased real-estate on the point-of-care diagnostic device, which is often constrained.

A further drawback of existing capsule manufacturing methods is that the process of heat-sealing the capsule can damage reagents that are sensitive to temperature changes. This can be mitigated by filling the capsule to a lower height so that there is a gap between the liquid reagent surface and the sealing region, to reduce the effect of temperature changes on the liquid reagent. However, this approach means that a larger capsule is required for a given volume of liquid reagent. Alternative approaches involve adjusting the temperature or contact time used in the sealing process, but these approaches may reduce the quality of the seal.

Accordingly, there exists a need for improved liquid handling apparatuses capable of addressing at least some of the issues explained above.

### SUMMARY

This summary introduces concepts that are described in more detail in the detailed description. It should not be used to identify essential features of the claimed subject matter, nor to limit the scope of the claimed subject matter.

According to a first aspect of the present disclosure, there is provided a liquid handling apparatus, comprising: a capsule configured to store a liquid reagent; a liquid handling device, comprising: a first conduit in fluidic communication with a first port; and a second conduit in fluidic communication with a second port; and a capsule interface mechanism configured to create: a first opening in the capsule in fluidic communication with the first port; and a second opening in the capsule in fluidic communication with the second port; wherein creating the first opening and the second opening allows the liquid reagent to be removed from the capsule.

Creating the first and second openings in the capsule allows the liquid reagent to be removed from the capsule via the first conduit and/or the second conduit. For example, air may be supplied via the first conduit to expel liquid reagent via the second conduit. By releasing liquid reagent from the capsule in this way, a large proportion of the liquid reagent can be removed from the capsule, meaning that in order to provide a certain volume of liquid reagent, smaller capsules are required than those used with existing liquid handling devices.

Creating the first and second openings in the capsule also allows the liquid reagent to be removed from the capsule without crushing a portion of the capsule that contains the liquid reagent. Consequently, liquid reagent does not become trapped within crushed material of the capsule.

The liquid handling device may further comprise a gas supply port configured to receive gas supplied by a variable pressure source; wherein the gas supply port is in fluidic communication with the first conduit; and wherein the first conduit is configured to supply gas received via the gas supply port to the first opening to expel liquid reagent from the second opening after the first and second openings have been created.

The capsule interface mechanism may be configured to create the second opening while creating the first opening. In this way, the openings in the capsule can be created using a single action.

The capsule interface mechanism may be configured to create the first and second openings in the same side of the capsule. For example, the capsule interface mechanism may be configured to create the first and second openings in a sealing layer of the capsule.

The capsule interface mechanism may be configured to create the second opening in a base of the capsule. Creating the second opening in a base of the capsule maximises the amount of liquid reagent that can be removed from the capsule, because the liquid reagent outlet (i.e. the second opening) is always below the liquid reagent level within the capsule.

The capsule may comprise a deformable material, wherein the capsule interface mechanism is configured to create the second opening in the capsule when the deformable material is deformed.

One or more of the capsule and the liquid handling device may comprise a compressible layer configured to bias the capsule apart from the capsule interface mechanism; wherein the capsule interface mechanism is configured to create the second opening in the capsule when the compressible layer is compressed.

The compressible layer may comprise a passageway in fluidic communication with the second conduit, wherein the passageway is configured to permit the flow of liquid reagent from the second opening through the compressible layer. The compressible layer therefore both biases the capsule apart from the capsule interface mechanism before the openings are created, and provides a route for liquid reagent that is released from the capsule to flow into the liquid handling device.

The capsule interface mechanism may comprise a puncturing element configured to puncture the capsule to create the second opening. The puncturing element may be disposed within the passageway.

The liquid handling device may comprise the capsule interface mechanism. Alternatively, the capsule may comprise at least a portion of the capsule interface mechanism.

The capsule may comprise: a liquid storage chamber configured to store the liquid reagent; an inlet chamber and an outlet chamber, wherein each of the inlet and outlet chambers is in fluidic communication with the liquid storage chamber; a first restriction configured to prevent the flow of liquid between the liquid storage chamber and the inlet chamber prior to creation of the openings in the capsule; and a second restriction configured to prevent the flow of liquid between the liquid storage chamber and the outlet chamber prior to creation of the openings in the capsule.

The restrictions between the chambers of the capsule mean that the liquid reagent can be released from the capsule in a controlled manner. In particular, the liquid reagent can be forced from the liquid storage chamber into the outlet chamber at the time the liquid reagent is required. This may be achieved by supplying air via the first opening (which may be in the inlet chamber) to expel liquid reagent via the second opening (which may be in the outlet chamber). Expelling liquid reagent in this way also avoids introducing air bubbles into the liquid reagent flow, because the liquid reagent can be expelled in one single volume.

In addition, the restrictions act as capillary stops that prevent liquid from filling the inlet and outlet chambers during storage of handling of the capsule.

The capsule interface mechanism may be configured to create the second opening in the outlet chamber. The capsule interface mechanism may be configured to create the first opening in the inlet chamber.

The cross-sectional area of the second restriction may be greater than or equal to the cross-sectional area of the second conduit. By having the cross-sectional area of the second restriction greater than or equal to the cross-sectional area of the second conduit, the flow rate of liquid reagent within the liquid handling device is not limited by the flow rate through the second restriction within the capsule. The cross-sectional area of the first restriction may also be greater than or equal to the cross-sectional area of the second conduit. The cross-sectional area of the first restriction may be greater than the cross-sectional area of the second restriction.

The outlet chamber may comprise a recess in a surface of a capsule body that defines the outlet chamber. Including a recess in a surface of the capsule body that defines the outlet chamber reduces the displacement of the capsule body required in order to create the second opening. This means that the deformation of the capsule body required in order to create the second opening is reduced, which means that less force is required in order to create the second opening. The inlet chamber may also comprise a recess in a surface of a capsule body that defines the inlet chamber.

The recess may be filled with a rigid material. Filling the recess with a rigid material means that the surface of the outlet chamber can be displaced without requiring an actuatable element that conforms to the shape of the recess (and without requiring precise localisation of the actuatable element within the recess). Accordingly, the second opening can be created in a more simple manner, without requiring such precise localisation of the liquid handling device within a liquid handling system that comprises the actuatable elements.

The capsule may comprise a sealing layer configured to seal an aperture in the capsule body; wherein the interior surface of the recess is in contact with the sealing layer prior to creation of the openings in the capsule. This means that any downward displacement of the recess (e.g. by an actuatable element of a liquid handling system) acts directly on the sealing layer. This minimises the force required to create the openings (and in turn, minimises the amount of deformation of the capsule body needed to create the openings).

The interior surface of the recess may be sealed to the sealing layer. This further reduces the amount of force required to create the openings, by preventing the sealing layer from sliding over the surface of the recess.

The liquid storage chamber may have a half-teardrop shape having a bulbous portion adjacent to the first restriction and an apex portion that provides a taper between the bulbous portion and the second restriction. The use of a half-teardrop shape for the liquid storage chamber minimises the free surface of the liquid reagent within the liquid storage chamber while maximising the volume of the liquid storage chamber and maximising the tendency of the liquid reagent to remain in a homogeneous volume that amalgamates towards the second restriction during release of the liquid reagent from the capsule (in other words, minimising the tendency of the liquid reagent to fragment within the liquid storage chamber during release of the reagent). The half-teardrop shape also minimises the tendency of the liquid reagent to fragment during settling of the liquid reagent after production of the capsule, and during handling of the capsule.

The shape of the bulbous portion may be defined by an inlet angle, wherein the inlet angle is the minimum angle between: a first line that is located on the plane of symmetry of the liquid storage chamber and is tangential to the surface of the bulbous portion; and a second line that is normal to the base of the capsule; the shape of the apex portion may be defined by an outlet angle, wherein the outlet angle is the minimum angle between: a third line that is located on the plane of symmetry of the liquid storage chamber and is tangential to the surface of the apex portion; and a fourth line that is normal to the base of the capsule; and the outlet angle may be larger than the inlet angle.

The inlet chamber may comprise: a lower portion having a truncated dome shape with a concave surface having a first curvature; and an upper portion joined to the lower portion, wherein the upper portion has a dome shape with a concave surface having a second curvature different to the first curvature; wherein the difference between the first curvature and the second curvature provides a step change in curvature at the join between the upper portion and the lower portion. The use of an inlet chamber with these portions ensures that any microbubbles in the fluid in the inlet chamber are trapped within the inlet chamber and retained around the periphery of the inlet chamber after liquid reagent has been released.

The outlet chamber may comprise: a lower portion having a truncated dome shape with a concave surface having a first curvature; and an upper portion joined to the lower portion, wherein the upper portion has a dome shape with a concave surface having a second curvature different to the first curvature; wherein the difference between the first curvature and the second curvature provides a step change in curvature at the join between the upper portion and the lower portion.

The capsule may comprise: a capsule body comprising a first aperture and a second aperture; a first sealing layer configured to seal the first aperture and a second sealing layer configured to seal the second aperture; wherein the area of the second aperture is less than the area of the first aperture. Using a second aperture provides flexibility in how the capsule is filled with liquid reagent. For example, a larger, main aperture (i.e. the first aperture) may be heat sealed, with the liquid reagent being subsequently filled via a smaller, second aperture. This avoids exposing the liquid reagent to the heat sealing process. In addition, using a smaller second aperture means that a greater proportion of the capsule can be filled (if, for example, the smaller second aperture is provided in a top surface of the capsule).

The capsule interface mechanism may be configured to create the first and second openings in the first sealing layer.

According to a second aspect of the present disclosure, there is provided a method of removing liquid reagent stored in a capsule attached to a liquid handling device, the method comprising: creating a first opening in the capsule and a second opening in the capsule; and supplying gas via the first opening to expel liquid reagent from the second opening.

Supplying the gas via the first opening may comprise: coupling a gas supply port of the liquid handling device to a variable pressure source configured to supply gas; and supplying gas from the variable pressure source to the first opening via a conduit in fluidic communication with the gas supply port and the first opening.

The method of the second aspect may be used to remove liquid reagent from a capsule of the liquid handling apparatus of the first aspect.

According to a third aspect of the present disclosure, there is provided a computer-readable medium comprising instructions that, when executed by a processor of a liquid handling system configured to receive a liquid handling apparatus, cause the liquid handling system to carry out the method of the second aspect.

According to a fourth aspect of the present disclosure, there is provided a method of manufacturing a liquid reagent capsule, the method comprising: heat sealing a first aperture in a capsule body using a first seal, thereby forming a vessel; filling the vessel with a liquid reagent via a second aperture in the capsule, wherein the area of the second aperture is less than the area of the first aperture; and sealing the second aperture using a second seal.

By constructing a capsule in this way, the liquid reagent in the capsule is not exposed to a heat-sealing process. This is because heat-sealing of the capsule is carried out before the capsule is filled with the liquid reagent. Therefore, if the liquid reagent is sensitive to temperature changes, it is not exposed to a heat sealing process that causes the liquid reagent to be damaged.

The second aperture may be sealed using a pressure-sensitive adhesive. This means that the second seal does not expose the liquid reagent to a heat sealing process.

According to a fifth aspect of the present disclosure, there is provided a capsule comprising: a liquid storage chamber configured to store a liquid reagent; an inlet chamber and an outlet chamber, wherein each of the inlet and outlet chambers is in fluidic communication with the liquid storage chamber; a first restriction configured to prevent the flow of liquid between the liquid storage chamber and the outlet chamber prior to the creation of openings in the capsule; and a second restriction configured to prevent the flow of liquid between the liquid storage chamber and the inlet chamber prior to the creation of openings in the capsule.

The restrictions between the chambers of the capsule mean that the liquid reagent can be released from the capsule in a controlled manner. In particular, the liquid reagent can be forced from the liquid storage chamber into the outlet chamber at the time the liquid reagent is required. In addition, the liquid reagent can be expelled without introducing air bubbles into the liquid reagent flow, because the liquid reagent can be expelled in one single volume.

In addition, the restrictions act as capillary stops that prevent liquid from filling the inlet and outlet chambers during storage of handling of the capsule. The cross-sectional area of the first restriction may be greater than the cross-sectional area of the second restriction.

The outlet chamber may comprise a recess in a surface of a capsule body that defines the outlet chamber. Including a recess in a surface of the capsule body that defines the outlet chamber reduces the displacement of the capsule body required in order to create the second opening. This means that the deformation of the capsule body required in order to create the second opening is reduced, which means that less force is required in order to create the second opening. The inlet chamber may also comprise a recess in a surface of a capsule body that defines the inlet chamber.

The recess may be filled with a rigid material. Filling the recess with a rigid material means that the surface of the outlet chamber can be displaced without requiring an actuatable element that conforms to the shape of the recess (and without requiring precise localisation of the actuatable element within the recess). Accordingly, the second opening can be created in a simpler manner, without requiring such precise localisation of the liquid handling device within a liquid handling system that comprises the actuatable elements.

The capsule may comprise a sealing layer configured to seal an aperture in the capsule body; wherein the interior surface of the recess is in contact with the sealing layer prior to creation of the openings in the capsule. This means that any downward displacement of the recess (e.g. by an actuatable element of a liquid handling system) acts directly on the sealing layer. This minimises the force required to create the openings (and in turn, minimises the amount of deformation of the capsule body needed to create the openings).

The interior surface of the recess may be sealed to the sealing layer. This further reduces the amount of force required to create the openings, by preventing the sealing layer from sliding over the surface of the recess.

The liquid storage chamber may have a half-teardrop shape having a bulbous portion adjacent to the first restriction and an apex portion that provides a taper between the bulbous portion and the second restriction. The use of a half-teardrop shape for the liquid storage chamber minimises the free surface of the liquid reagent within the liquid storage chamber while maximising the volume of the liquid storage chamber and maximising the tendency of the liquid reagent to remain in a homogeneous volume that amalgamates towards the second restriction during release of the liquid reagent from the capsule (in other words, minimising the tendency of the liquid reagent to fragment within the liquid storage chamber during release of the reagent). The half-teardrop shape also minimises the tendency of the liquid reagent to fragment during settling of the liquid reagent after production of the capsule, and during handling of the capsule.

The shape of the bulbous portion may be defined by an inlet angle, wherein the inlet angle is the minimum angle between: a first line that is located on the plane of symmetry of the liquid storage chamber and is tangential to the surface of the bulbous portion; and a second line that is normal to the base of the capsule; the shape of the apex portion may be defined by an outlet angle, wherein the outlet angle is the minimum angle between: a third line that is located on the plane of symmetry of the liquid storage chamber and is tangential to the surface of the apex portion; and a fourth line that is normal to the base of the capsule; and the outlet angle may be larger than the inlet angle.

The inlet chamber may comprise: a lower portion having a truncated dome shape with a concave surface having a first curvature; and an upper portion joined to the lower portion, wherein the upper portion has a dome shape with a concave surface having a second curvature different to the first curvature; wherein the difference between the first curvature and the second curvature provides a step change in curvature at the join between the upper portion and the lower portion. The use of an inlet chamber with these portions ensures that any microbubbles in the fluid in the inlet chamber are trapped within the inlet chamber and retained around the periphery of the inlet chamber after liquid reagent has been released.

The outlet chamber may comprise: a lower portion having a truncated dome shape with a concave surface having a first curvature; and an upper portion joined to the lower portion, wherein the upper portion has a dome shape with a concave surface having a second curvature different to the first curvature; wherein the difference between the first curvature and the second curvature provides a step change in curvature at the join between the upper portion and the lower portion.

The capsule may comprise: a capsule body comprising a first aperture and a second aperture; a first sealing layer configured to seal the first aperture and a second sealing layer configured to seal the second aperture; wherein the area of the second aperture is less than the area of the first aperture.

The capsule of the fifth aspect may further comprise any of the features of the capsule used with the liquid handling apparatus of the first aspect.

### BRIEF DESCRIPTION OF FIGURES

Specific embodiments are described below by way of example only and with reference to the accompanying drawings, in which:

FIG. 1 is a schematic diagram of a capsule attached to a liquid handling device.

FIG. 2 is a schematic diagram showing a port of the liquid handling device shown in FIG. 1.

FIG. 3 is a schematic diagram of the liquid handling device shown in FIGS. 1 and 2 coupled to a variable pressure source.

FIG. 4 is a schematic diagram of a deformable capsule attached to the liquid handling device shown in FIG. 1.

FIG. 5A is a schematic diagram of a deformable capsule attached to an alternative liquid handling device.

FIG. 5B is a schematic diagram showing the deformable capsule shown in FIG. 5A in a deformed state.

FIG. 6A is a schematic diagram of an alternative deformable capsule attached to the liquid handling device shown in FIG. 5A.

FIG. 6B is a schematic diagram showing the alternative deformable capsule shown in FIG. 6A in a deformed state.

FIG. 7A is a schematic diagram of a further alternative deformable capsule attached to the liquid handling device shown in FIG. 5A.

FIG. 7B is a schematic diagram showing the further alternative deformable capsule shown in FIG. 7A in a deformed state.

FIG. 8 is a schematic diagram of a capsule comprising a compressible layer attached to a liquid handling device.

FIG. 9 is a schematic diagram showing puncturing of the capsule shown in FIG. 8.

FIG. 10A is an isometric view of a first capsule comprising a liquid storage chamber with a teardrop shape.

FIG. 10B is a top view of the first capsule shown in FIG. 10A.

FIG. 10C is a side view of the first capsule shown in FIG. 10A.

FIG. 10D shows a simulation of free surfaces of a first liquid reagent within the first capsule shown in FIG. 10A prior to release of the first liquid reagent from the first capsule.

FIG. 10E shows a simulation of free surfaces of a second liquid reagent within the first capsule shown in FIG. 10D during release of the second liquid reagent from the first capsule.

FIG. 10F shows an alternative capsule defined by parameters that have been adjusted to minimise fragmentation of the second liquid reagent shown in FIG. 10E.

FIG. 11A is an isometric view of a second capsule comprising a liquid storage chamber with a teardrop shape.

FIG. 11B is a top view of the second capsule shown in FIG. 11A.

FIG. 11C is a side view of the second capsule shown in FIG. 11A.

FIG. 12A is an isometric view of a third capsule comprising a liquid storage chamber with a teardrop shape.

FIG. 12B is a top view of the third capsule shown in FIG. 12A.

FIG. 12C is a side view of the third capsule shown in FIG. 12A.

FIG. 12D shows a simulation of free surfaces of a liquid reagent within the third capsule shown in FIG. 12A.

FIG. 13A is an isometric view of a fourth capsule comprising a liquid storage chamber with a teardrop shape.

FIG. 13B is a top view of the fourth capsule shown in FIG. 13A.

FIG. 13C is a side view of the fourth capsule shown in FIG. 13A.

FIG. 14 is a schematic diagram of a capsule comprising a liquid storage chamber with a teardrop shape when the capsule is attached to the liquid handling device shown in FIG. 1.

FIG. 15A is an isometric view of a capsule comprising a liquid storage chamber with a flattened dome shape.

FIG. 15B is a top view of the capsule shown in FIG. 15A.

FIG. 15C is a side view of the capsule shown in FIG. 15A.

FIG. 16A is an isometric view of a capsule comprising a liquid storage chamber with an elongate shape.

FIG. 16B is a top view of the capsule shown in FIG. 16A.

FIG. 16C is a side view of the capsule shown in FIG. 16A.

FIG. 17A is an isometric view of a capsule comprising a U-shaped liquid storage chamber.

FIG. 17B is a top view of the capsule shown in FIG. 17A.

FIG. 18 is a flowchart of a method of removing liquid reagent stored in a capsule.

FIG. 19 is a schematic diagram showing the construction of a capsule.

FIG. 20 is a flowchart of a method of manufacturing a liquid reagent capsule.

### DETAILED DESCRIPTION

Implementations of the present disclosure are explained below with particular reference to liquid reagent storage. It will be appreciated, however, that the capsules disclosed herein may be used to store any type of liquid and are not limited to storing reagents. References herein to a capsule that is “configured to” store a liquid reagent should not be taken to mean that the capsule is limited to storing a liquid reagent.

### Overview

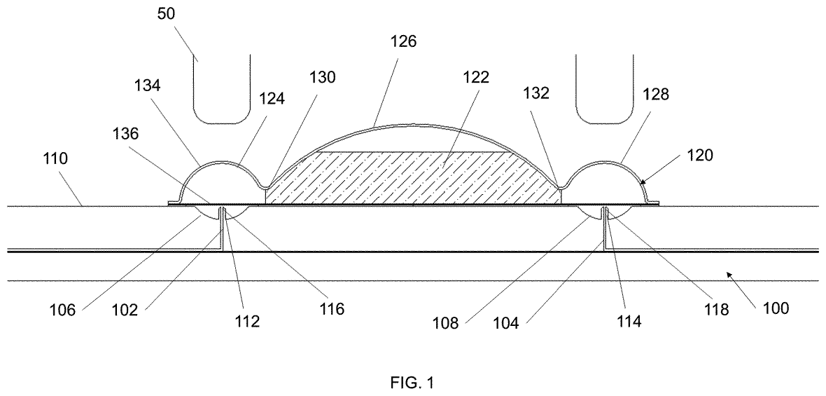

FIG. 1 is a schematic diagram of a liquid handling device 100 (e.g. a cartridge such as a microfluidic cartridge), to which a capsule 120 is attached. Together, the liquid handling device 100 and the capsule 120 comprise a liquid handling apparatus.

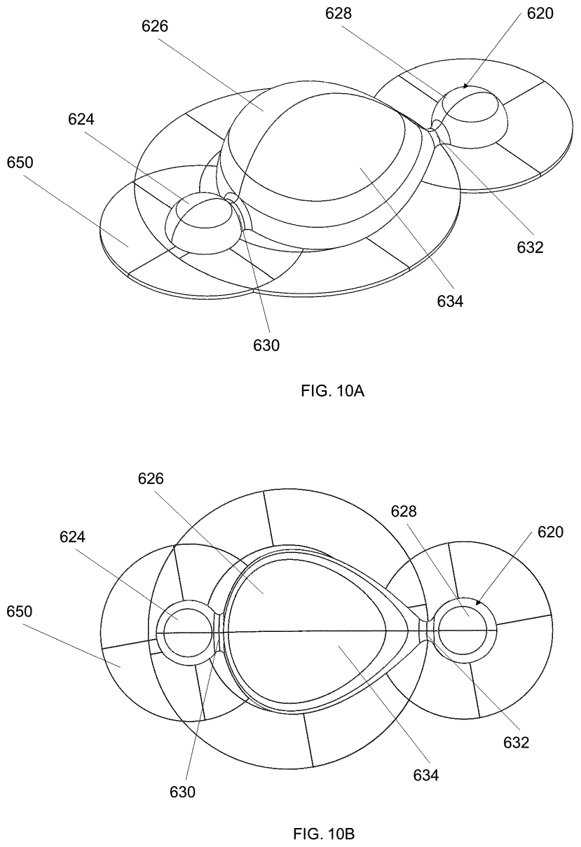

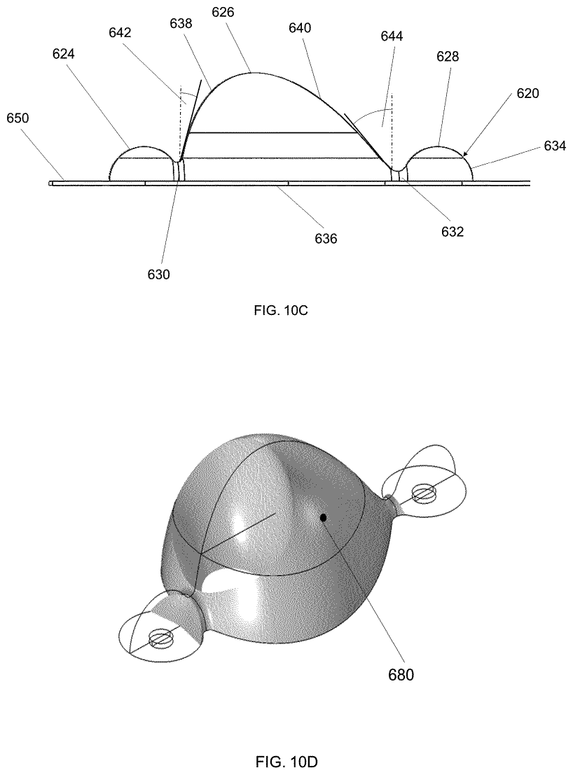

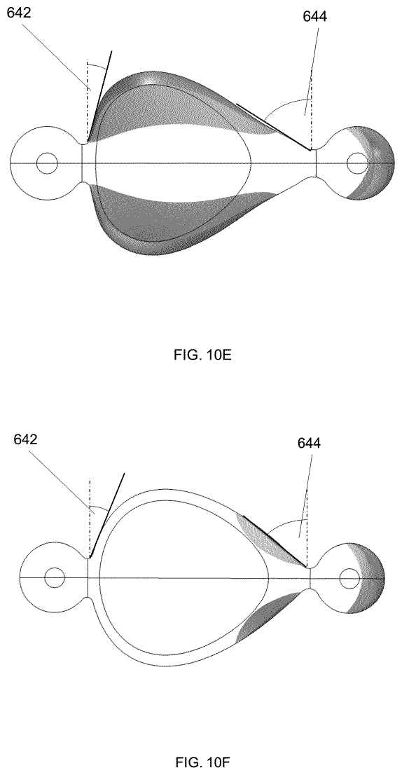

The capsule 120 stores a liquid reagent 122. The capsule 120 includes three portions: an inlet chamber 124, a liquid storage chamber 126, and an outlet chamber 128 (described in more detail with reference to FIGS. 10A to 10C). The capsule 120 also includes a first restriction 130 between the inlet chamber 124 and the liquid storage chamber 126, and a second restriction 132 between the liquid storage chamber 126 and the outlet chamber 128. Each of the first and second restrictions 130, 132 is provided in the form of a neck (or narrowed region) between the liquid storage chamber 126 and the inlet/outlet chamber. The inlet chamber 124 is in fluidic communication with the liquid storage chamber 126 via the first restriction 130. The outlet chamber 128 is in fluidic communication with the liquid storage chamber 126 via the second restriction 132.

The first restriction 130 is sized to minimise the flow of liquid reagent into the inlet chamber 124. Likewise, the second restriction 132 is sized to minimise the flow of liquid reagent into the outlet chamber 128. To minimise the flow of liquid reagent, the first and second restrictions 130, 132 are narrow enough that the surface tension of the liquid reagent prevents the liquid reagent from flowing through the restrictions 130, 132. This means that the first and second restrictions 130, 132 act as capillary stops that prevent the flow of liquid from the liquid storage chamber 126 to the inlet and outlet chambers 124, 128 prior to creation of openings in the capsule 120.

The capsule 120 comprises a capsule body 134 that defines the shape of the liquid storage chamber 126, the inlet chamber 124, the outlet chamber 128 and the first and second restrictions 130, 132. The capsule body 134 includes one or more apertures via which the capsule 120 is filled (in the example shown in FIG. 1, the capsule body 134 includes a single aperture). The capsule 120 further comprises a sealing layer 136 that seals the aperture. The capsule body 134 may be formed, for example, by injection moulding using a polymeric material such as polypropylene (PP), high-density polyethylene (HDPE), or cyclic olefin copolymer (COC), by thermoforming using a polymeric material such as polyvinyl chloride (PVC), polyethylene terephthalate (PET), or polychlorotrifluoroethylene (PCTFE), or by cold forming using an aluminium-based laminate film, which typically comprises at least three layers: a plastic film (e.g. PVC, PP, PE), an aluminium layer, and a polyamide layer. The sealing layer 136 may be formed of a thin aluminium-based laminate film (also known as lid foil, push-through foil, or easy pierceable foil).

The liquid handling device 100 includes a surface 110 that is in contact with the capsule 120. The capsule 120 is attached to the liquid handling device 100 using a layer of adhesive (not shown) between the sealing layer 136 and the surface 110.

The liquid handling device 100 also includes a first conduit 102 and a second conduit 104, each of which may be provided within a fluidic layer of the liquid handling device 100. The first conduit 102 is in fluidic communication with a first port 116. The second conduit 104 is in fluidic communication with a second port 118. The liquid handling device 100 also includes a capsule interface mechanism in the form of a first puncturing element 112 and a second puncturing element 114.

The first puncturing element 112 and the second puncturing element 114 are each configured to create an opening in the capsule 120 by puncturing (or rupturing) the sealing layer 136 of the capsule 120.

Specifically, the first puncturing element 112 is configured to create a first opening into the inlet chamber 124 by puncturing the sealing layer 136 located below the inlet chamber 124 (when the capsule 120 is oriented with the sealing layer 136 downwards).

Likewise, the second puncturing element 114 is configured to create a second opening into the outlet chamber 128 by puncturing the sealing layer 136 located below the outlet chamber 128 (when the capsule 120 is oriented with the sealing layer 136 downwards).

As shown in FIG. 1, the first puncturing element 112 is configured to create the first opening in fluidic communication with the first port 116 (and therefore in fluidic communication with the first conduit 102). In the example shown in FIG. 1, the first conduit 102 extends through the first puncturing element 112 to define the first port 116 at the top of the first puncturing element 112, meaning that the first opening is in fluidic communication with the first port 116 once created by the first puncturing element 112. Likewise, the second puncturing element 114 is configured to create the second opening in fluidic communication with the second port 118 (and therefore in fluidic communication with the second conduit 104). In the example shown in FIG. 1, the second conduit 104 extends through the second puncturing element 114 to define the second port 118 at the top of the second puncturing element 114, meaning that the second opening is in fluidic communication with the second port 118 once created by the second puncturing element 114.

Using first and second conduits 102, 104 that extend through the puncturing elements 112, 114 prevents the ports 116, 118 from becoming blocked by loose portions of the sealing layer 136 after the openings have been created in the sealing layer 136.

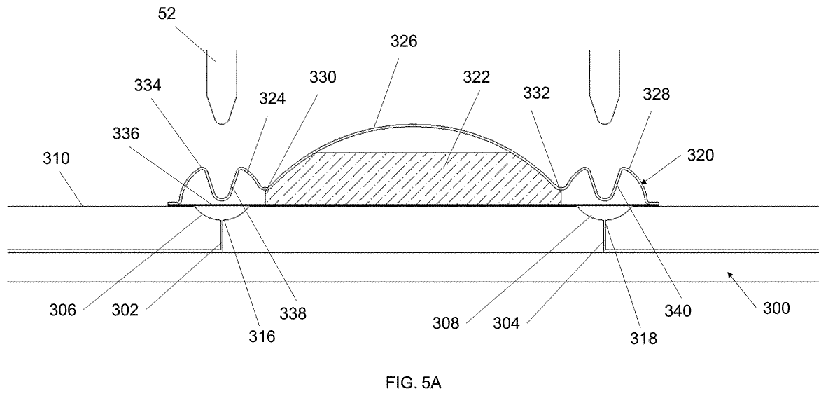

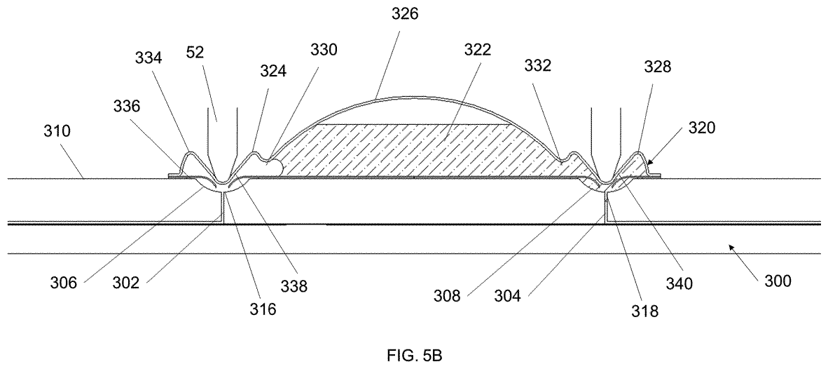

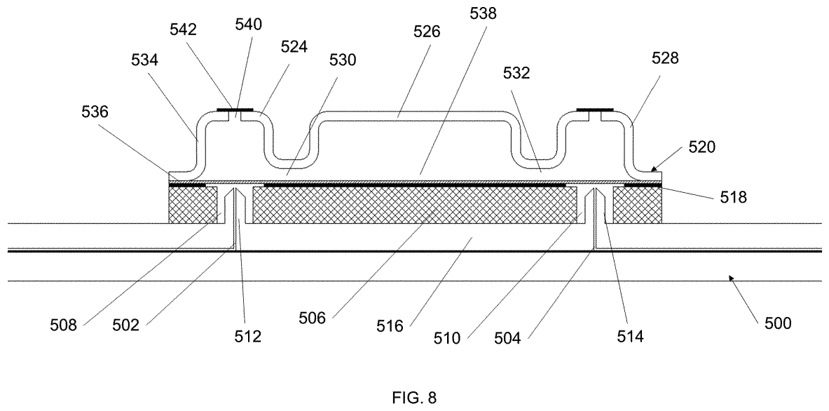

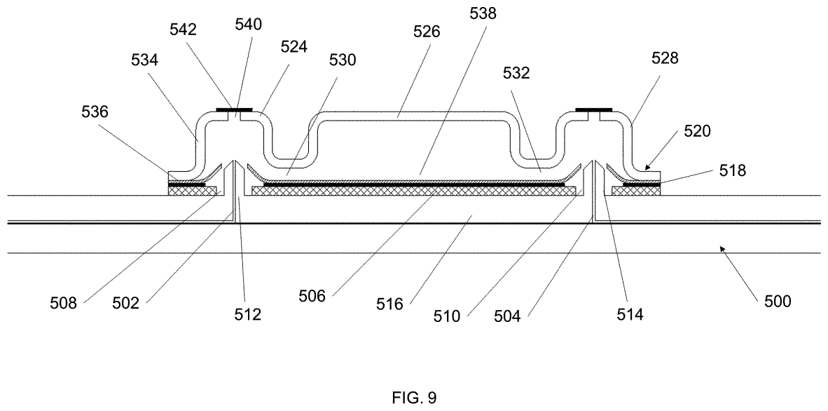

The first puncturing element 112 and the second puncturing element 114 are configured to create the openings in the capsule 120 by relative movement of the puncturing elements 112, 114 towards the capsule 120. The relative movement of the puncturing elements 112, 114 towards the capsule 120 may be provided by applying a force to a deformable capsule (e.g. as described with reference to FIGS. 5 to 7). For example, the force may be applied by actuatable elements 50 (described below) of a liquid handling system in which the liquid handling apparatus (i.e. the liquid handling device 100 and capsule 120) is received. Alternatively or additionally, the relative movement of the puncturing elements 112, 114 towards the capsule 120 may be provided by compression of a compressible layer of the capsule (e.g. as described with reference to FIG. 8 and FIG. 9) or a compressible layer in the liquid handling device.

In the example shown in FIG. 1, the first puncturing element 112 is provided in a first depression 106, and the second puncturing element 114 is provided in a second depression 108. Each of the depressions 106, 108 is formed in the surface 110 of the liquid handling device 100 in contact with the capsule 120. Each of the depressions 106, 108 may also comprise an opening (not shown) in fluidic communication with the respective conduit 102, 104. The opening is provided at the base of the puncturing element 112, 114 within the depression 106, 108, to allow any liquid reagent within the depression 106, 108 to drain into the respective conduit 102, 104.

In the case of a deformable capsule (e.g. as described with reference to FIGS. 5 to 7), the depressions 106, 108 allow the sealing layer of the capsule to deform when a compressive force is applied to the capsule, meaning that the sealing layer is brought into contact with the puncturing elements 112, 114. To allow the sealing layer to deform into the depressions 106, 108, the layer of adhesive does not extend over the region in which the depressions 106, 108 are located.

However, in the case of a capsule with a compressible layer (e.g. as described with reference to FIG. 8 and FIG. 9), deformation of the sealing layer prior to puncture is not required, meaning that the depressions 106, 108 may not be provided. Instead, as described with reference to FIG. 8 and FIG. 9, each puncturing element may be provided within a passageway in the compressible layer that allows liquid reagent to flow through the compressible layer. Alternatively, if the compressible layer is positioned, for example, below the liquid storage chamber only, the puncturing elements may be provided in respective voids located below the inlet chamber and the outlet chamber.

Creating the first and second openings in the capsule 120 allows the liquid reagent 122 to be removed from the capsule 120 via the first conduit 102 and/or the second conduit 104. As one example, a gas (e.g. air) may be supplied to the capsule 120 via the first conduit 102 and the first opening. Supplying gas to the capsule 120 displaces the liquid reagent 122 within the capsule 120, forcing the liquid reagent 122 out of the second opening and into the second conduit 104. The liquid reagent 122 can then be transported to one or more components of the liquid handling device 100 as required by the diagnostic test or assay being conducted.

FIG. 1 shows two actuatable elements 50 of a liquid handling system (not shown) in which the liquid handling device 100 is received. As explained above, the actuatable elements 50 may apply a force to deform the capsule 120 in order to provide relative movement of the puncturing elements 112, 114 towards the capsule 120 or, in the case of a rigid (i.e. non-deformable) capsule, may apply a force to compress a compressible layer of the capsule 120 in order to provide relative movement of the puncturing elements 112, 114 towards the capsule 120. Specifically, one of the actuatable elements 50 applies a force to the inlet chamber 124 of the capsule 120, and another one of the actuatable elements 50 applies a force to the outlet chamber 128 of the capsule 120.

The actuatable elements 50 may be configured to apply a force to the capsule 120 at the same time. For example, one of the actuatable elements 50 may be configured to apply a force to the capsule 120 while a force is being applied to the capsule 120 by the other one of the actuatable elements 50. By applying a force to the capsule 120 at the same time, the openings in the capsule 120 can be created using a single action (e.g. a single downward movement of the actuatable elements 50).

As shown in FIG. 1, the relative movement of the puncturing elements 112, 114 towards the capsule 120 creates the openings in the capsule 120 in the same side of the capsule 120 (specifically, in the sealing layer 136 of the capsule). In the example shown in FIG. 1, the puncturing elements 112, 114 are configured to create the first and second openings in a base of the capsule 120. Creating the second opening in a base of the capsule 120 maximises the amount of liquid reagent 122 that can be removed from the capsule 120, because the liquid reagent outlet (i.e. the second opening) is always below the liquid reagent level within the capsule 120.

The first and second restrictions 130, 132 have a larger cross-sectional area than the cross-sectional area of the second conduit 102. This ensures that the flow rate of liquid reagent within the liquid handling device 100 is not limited by the size of the restrictions 130, 132 in the capsule 120.

### Supplying Gas to Expel Liquid Reagent

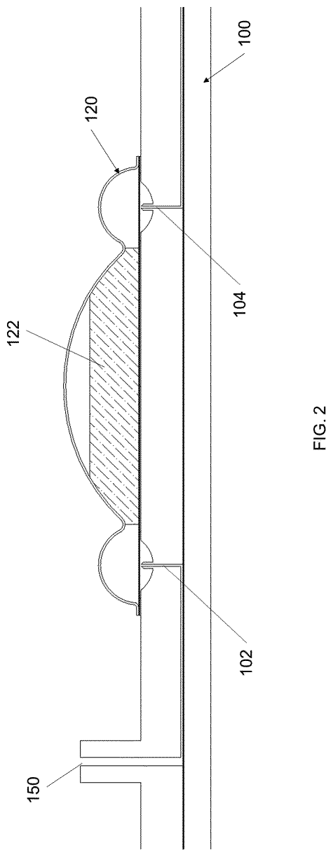

FIG. 2 is a schematic diagram showing the liquid handling device 100 in FIG. 1 further comprising a gas supply port in the form of air supply port 150, which is in fluidic communication with the first conduit 102.

In use, gas (e.g. air) is supplied via the air supply port 150 into the first conduit 102 after the first opening has been created in the capsule 120. The fluidic communication between the first conduit 102 and the first opening allows air to be supplied to the capsule 120. After the second opening has been created in the capsule 120, the pressurised air forces the liquid reagent out of the second opening and into the second conduit 104.

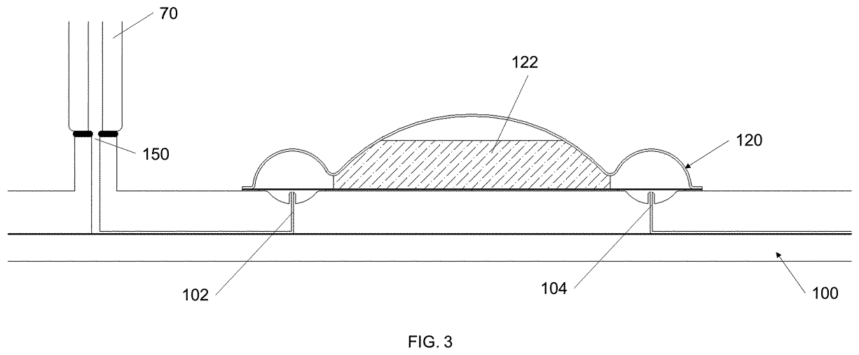

As shown in FIG. 3, the air may be supplied to the port by an air supply conduit 70 coupled to a variable pressure source (e.g. a pump). The air supply conduit 70 may be a component of a liquid handling system in which the liquid handling apparatus is received. For example, the air supply conduit 70 may be a component of the same liquid handling system that comprises the actuatable elements 50.

### Deformable Capsule

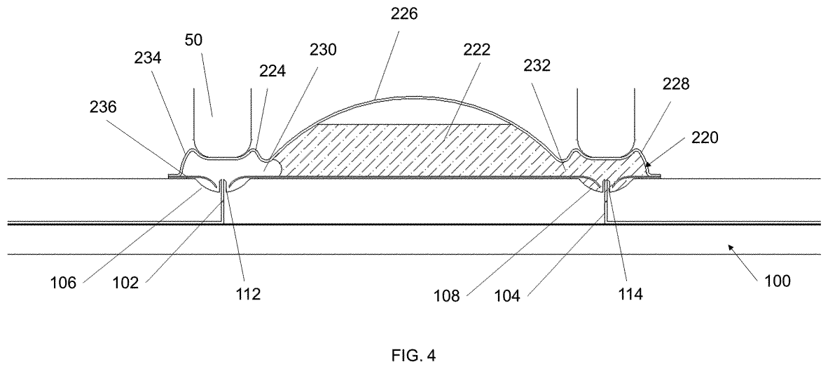

FIG. 4 is a schematic diagram showing a deformable capsule 220 attached to the liquid handling device 100. The capsule 220 comprises a capsule body 234 that is deformable. The capsule 220 comprises an inlet chamber 224, liquid storage chamber 226, outlet chamber 228, first restriction 230 and second restriction 232, having the same functionality as, respectively, the inlet chamber 124, liquid storage chamber 126, outlet chamber 128, first restriction 130 and second restriction 132 described with reference to FIG. 1. As with the capsule 120 shown in FIG. 1, the capsule 220 includes a liquid reagent 222 and is sealed using a sealing layer 236.

FIG. 4 shows the capsule body 234 is shown in its deformed state. In particular, FIG. 4 shows the capsule 220 after forces are applied to the inlet chamber 224 and the outlet chamber 228 by the actuatable elements 50.

Taking the inlet chamber 224 as an example, the force applied by the actuatable element 50 on the inlet chamber 224 compresses the inlet chamber 224, thereby reducing its volume. The reduction in volume of the inlet chamber 224 compresses the air within the inlet chamber 224, which forces the sealing layer 236 to bulge outwards into the first depression 106 in which the first puncturing element 112 is located. This causes the sealing layer 236 into contact with the first puncturing element 112, meaning that the first puncturing element 112 punctures the sealing layer 236 below the inlet chamber 224. The sealing layer 236 below the outlet chamber 228 is punctured in the same way by the second puncturing element 114.

### Alternative Capsule Interface Mechanism

FIGS. 5A and 5B are a schematic diagrams of an alternative liquid handling device 300 (e.g. a cartridge), to which a capsule 320 storing a liquid reagent 322 is attached. As with the liquid handling device 100 shown in FIG. 1, the liquid handling device 300 in FIGS. 5A and 5B includes a first conduit 302 and a second conduit 304, each of which may be provided within a fluidic layer of the liquid handling device 300.

The liquid handling device 300 comprises a first depression 306 and a second depression 308, each of which is provided in a surface 310 of the liquid handling device 300 in contact with the capsule 320. The first depression 306 is in fluidic communication with the first conduit 302 via a first port 316 in a surface of the first depression 306. Likewise, the second depression 308 is in fluidic communication with the second conduit 304 via a second port 318 in a surface of the second depression 308.

As with the capsule 120 shown in FIG. 1, the capsule 320 shown in FIGS. 5A and 5B includes an inlet chamber 324, a liquid storage chamber 326, an outlet chamber 328, a first restriction 330, a second restriction 332, a capsule body 334 and a sealing layer 336. Each of these components has the same functionality as described above for the capsule 120 shown in FIG. 1.

In addition, the capsule 320 comprises a first recess 338 in the portion of the capsule body 334 that defines the upper surface of the inlet chamber 324. The capsule 320 also includes a second recess 340 in the portion of the capsule body 334 that defines the upper surface of the outlet chamber 328.

The depressions 306, 308 in the surface 310 of the liquid handling device 300 and the recesses 338, 340 in the capsule body 334 together form a capsule interface mechanism that allows the openings to be created in the sealing layer 336 of the capsule 320.

FIGS. 5A and 5B show two actuatable elements 52 of a liquid handling system (not shown) in which a liquid handling apparatus (i.e. the liquid handling device 300 and capsule 320) is received. An end portion of one of the actuatable elements 52 is configured to fit within the first recess 338, and an end portion of another one of the actuatable elements 52 is configured to fit within the second recess 340. The recesses 338, 340 and/or actuatable elements 52 may be sized to allow the end portions of the actuatable elements 52 to fit within the recesses 338, 340.

As with the capsule 220 shown in FIG. 4, the capsule body 334 of the capsule 320 is deformable. FIG. 5A shows the capsule body 334 in its undeformed state, while FIG. 5B shows the capsule body 334 in its deformed state.

One of the actuatable elements 52 is configured to apply a force to the inlet chamber 324 by applying a downward force to the recess 338. Another one of the actuatable elements 52 is configured to apply a force to the outlet chamber 328 by applying a downward force to the recess 340.

Taking the inlet chamber 324 as an example, the force applied by the actuatable element 52 on the recess 338 compresses the inlet chamber 324, thereby reducing its volume. The reduction in volume of the inlet chamber 324 compresses the air within the inlet chamber 324, which forces the sealing layer 336 to stretch outwards into the first depression 306. The stretching of the sealing layer 336 causes the sealing layer 336 to rupture, thereby creating an opening in the sealing layer 336. The sealing layer 336 below the outlet chamber 328 is punctured in the same way by the second puncturing element 114.

The capsule interface mechanism in the form of the depressions 306, 308 and recesses 338, 340 allow the sealing layer 336 of the capsule 320 to be deformed into the depressions 306, 308 when forces are applied to the recesses 338, 340. This allows the openings to be created in the sealing layer 336. As shown in FIGS. 5A and 5B, the first conduit 302 is in fluidic communication with the first depression 306 via the first port 316 and the second conduit 304 is in fluidic communication with the second depression 308 via the second port 318. Consequently, the first depression 306 allows an opening in the sealing layer 336 to be created in fluidic communication with the first port 316. Likewise, the second depression 308 allows an opening in the sealing layer 336 to be created in fluidic communication with the second port 318.

In some examples, the sealing layer 336 is sufficiently inelastic such that the action of the compressed air within the inlet chamber 324 on the sealing layer 336 causes the sealing layer 336 to rupture. In other examples, the sealing layer 336 may be deformed into the depressions 306, 308 by the compressive force from the actuatable elements 52 being exerted on the sealing layer 336, thereby causing the sealing layer 336 to deform into the depressions 306, 308 and subsequently rupture.

In examples where the actuatable elements 52 exert a compressive force on the sealing layer 336, each recess 338, 340 may be formed so as to minimise the distance between the base of the recess 338, 340 and the sealing layer 336. By minimising the distance between the base of the recess 338, 340 and the sealing layer 336, the displacement of the actuatable elements 52 required for the actuatable elements 52 to contact the sealing layer 336 is minimised. This means that the amount of force required to deform the capsule body 334 is, in turn, minimised.

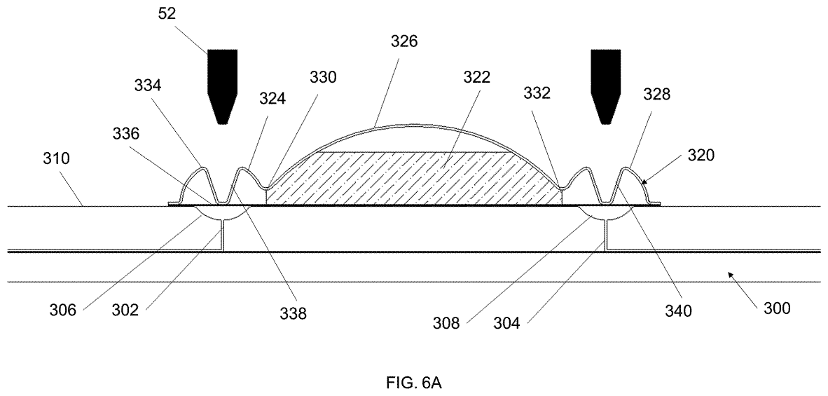

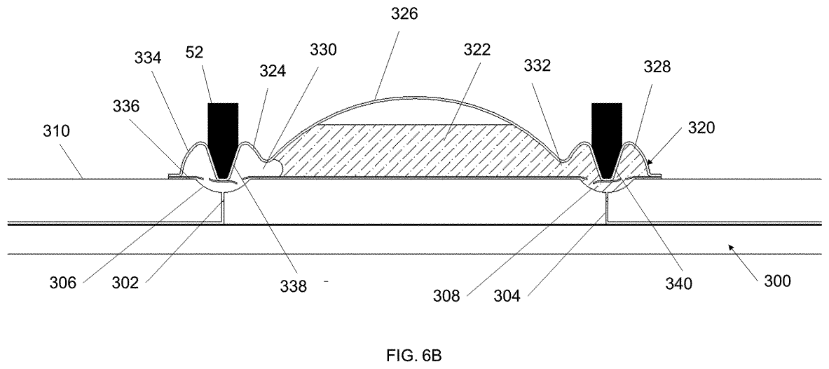

For example, as shown in FIG. 6A (undeformed capsule) and FIG. 6B (deformed capsule), each recess 338, 340 may be formed so that the interior surface of each recess 338, 340 is in contact with the sealing layer 336. This means that once the actuatable elements 52 are fully inserted in the recesses 338, 340, any further downward displacement of the actuatable elements 52 acts directly on the sealing layer 336. This minimises the force required to break the sealing layer 336 (and in turn, minimises the amount of deformation of the capsule body 334 needed to break the sealing layer 336). As best shown in FIG. 6B, the sealing layer 336 may be sealed against the interior surface of each recess 338, 340, which prevents the sealing layer 336 from sliding over the interior surface of each recess 338, 340. This further reduces the amount of force required to rupture the sealing layer 336.

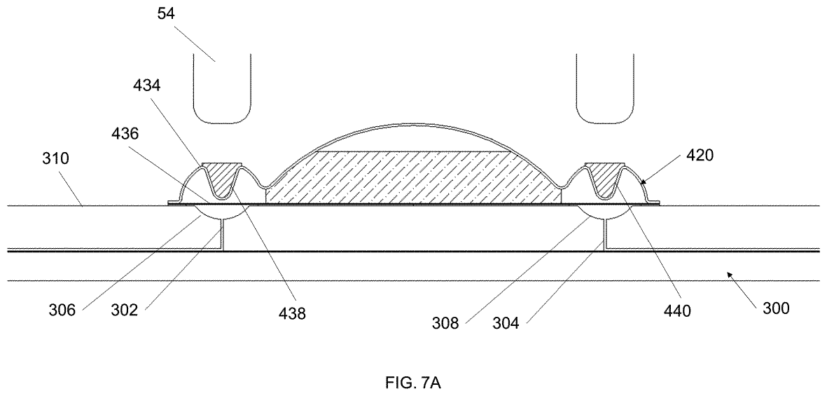

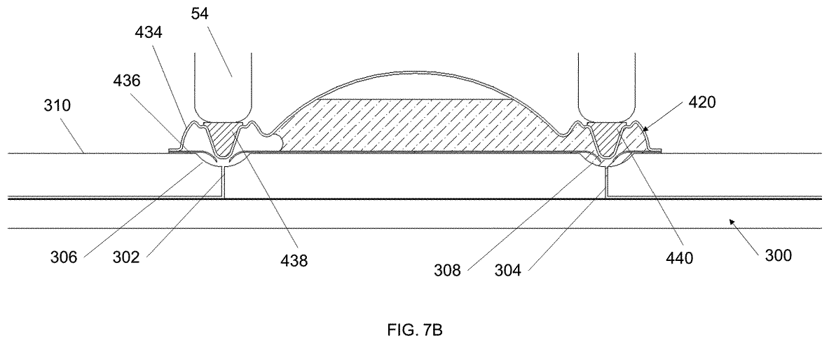

FIGS. 5A to 6B show that the recesses 338, 340 have a profile that conforms to the ends of the actuatable elements 52. In an alternative example shown in FIGS. 7A and 7B, a capsule 420 with filled recesses 438, 440 is shown. As with the examples shown in FIGS. 5A to 6B, the recesses 438, 440 are formed in a capsule body 434 of the capsule 420. In the example shown in FIGS. 7A and 7B, however, the first recess 438 and the second recess 440 are each filled with a rigid material such as a resin, that provides a substantially flat surface for engagement by first and second actuatable elements 54. In this example, the ends of the actuatable elements 54 do not conform to the shape of the recesses 438, 440.

The openings are created in a sealing layer 436 in the same way as for the examples described with reference to FIGS. 5A to 6B, except that the actuatable elements 54 apply a force to the rigid material within the recesses 438, 440. The force applied by the actuatable elements 54 compresses the capsule body 434. The openings in the sealing layer 436 may be formed by rupture of an inelastic sealing layer material, or by deformation of the sealing layer 436 by the force applied to the filled recesses 438, 440 by the actuatable elements 54 (both as described above for FIGS. 5A to 6B).

Filling the recesses 438, 440 to provide a surface for engagement by the actuatable elements 54 means that the ends of the actuatable elements 54 do not need to conform to the shape of the recesses 438, 440. Consequently, actuatable elements 54 with blunt ends (e.g. as shown in FIGS. 7A and 7B) can be used to apply the compressive force to the capsule 420. As with the example shown in FIGS. 6A and 6B, the filled recesses 438, 440 may be provided in contact with the sealing layer 436 and, if so, may be sealed to the sealing layer 436.

### Compressible Layer

FIG. 8 shows an alternative liquid handling device 500 (e.g. a cartridge) to which a capsule 520 comprising a liquid reagent (not shown) is attached. As with the liquid handling devices described above, the liquid handling device 500 includes a first conduit 502 and a second conduit 504, each of which may be provided within a fluidic layer of the liquid handling device 500.

As with the capsules described above, the capsule 520 shown in FIG. 8 includes an inlet chamber 524, a liquid storage chamber 526, an outlet chamber 528, a first restriction 530, a second restriction 532, a capsule body 534 and a sealing layer. Each of these components has the same functionality as the corresponding component of the capsules described above. In this example, the sealing layer is a first sealing layer 536.

The capsule 520 also comprises a compressible layer 506 comprising a first passageway 508 and a second passageway 510. The compressible layer 506 is shown in an uncompressed state in FIG. 8. The compressible layer 506 is disposed between the first sealing layer 536 and a rigid layer 516 of the liquid handling device 500. The compressible layer 506 is attached to the first sealing layer 536 using an adhesive layer 518 between the first sealing layer 536 and the compressible layer 506.

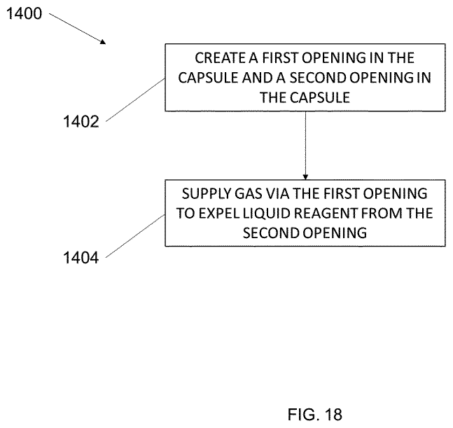

The capsule body 534 comprises a first aperture 538 at the base of the capsule 520. The first aperture 538 is sealed by the first sealing layer 536. In addition, the capsule body 534 comprises one or more second apertures 540 (in the example shown in FIG. 8, two second apertures 540 are shown). Each of the one or more second apertures 540 is sealed by a corresponding second sealing layer 542. The apertures 538, 540 allow for filling of the capsule 520, as described below with reference to FIG. 18.

Although the capsule body 534 is shown in FIG. 8 as having the first aperture 538 and the one or more second apertures 540, the capsules attached to the liquid handling device 500 may alternatively take the form of the capsule 120 shown in FIG. 1 or the capsules described below with reference to FIGS. 10A to 17B.

The liquid handling device comprises a capsule interface mechanism in the form of a first puncturing element 512 and a second puncturing element 514. The puncturing elements 512, 514 may be formed integrally with the rigid layer 516. The puncturing elements 512, 514 and/or the passageways 508, 510 in the compressible layer 506 are configured such that the first puncturing element 512 is located within the first passageway 508 and the second puncturing element 514 is located within the second passageway 510 when the capsule 520 is attached to the liquid handling device 500.

The first puncturing element 512 and the second puncturing element 514 are each configured to create an opening in the capsule 520 by puncturing the first sealing layer 536 of the capsule 520. Specifically, the first puncturing element 512 is configured to create a first opening into the inlet chamber 524 by puncturing the first sealing layer 536 located below the inlet chamber 524 (when the capsule 520 is oriented with the first sealing layer 536 downwards). Likewise, the second puncturing element 514 is configured to create a second opening into the outlet chamber 528 by puncturing the first sealing layer 536 located below the outlet chamber 528 (when the capsule 520 is oriented with the first sealing layer 536 downwards).

As shown in FIG. 8, the first puncturing element 512 is configured to create the first opening in fluidic communication with the first conduit 502. In the example shown in FIG. 8, the first conduit 502 extends through the first puncturing element 512 to define a first port in the first puncturing element 512, meaning that the first opening is in fluidic communication with the first port (and thereby the first conduit 502) once created by the first puncturing element 512.

Likewise, the second puncturing element 514 is configured to create the second opening in fluidic communication with the second conduit 504. In the example shown in FIG. 8, the second conduit 504 extends through the second puncturing element 514 to define a second port in the second puncturing element 514, meaning that the second opening is in fluidic communication with the second port (and thereby the second conduit 504) once created by the second puncturing element 514.

The first puncturing element 512 and the second puncturing element 514 are configured to create the openings in the capsule 520 by relative movement of the puncturing elements 512, 514 towards the capsule 520. In the example shown in FIG. 8, the relative movement of the puncturing elements 512, 514 towards the capsule 520 is achieved by compression of the compressible layer 506, which brings the puncturing elements 512, 514 into contact with the first sealing layer 536 to puncture the first sealing layer 536.

FIG. 9 shows the compressible layer 506 in a compressed state. As shown in FIG. 9, compression of the compressible layer 506 provides relative movement of the puncturing elements 512, 514 towards the capsule 520, thereby causing the puncturing elements 512, 514 to puncture the first sealing layer 536.

The compressible layer 506 may be compressed by a force applied to the capsule body 534 (as with the examples described with reference to FIGS. 1-7). For example, if the capsule body 534 comprises a rigid material (or a material that is less compressible than the compressible layer 506), the force applied to the capsule body 534 will be transferred to the compressible layer 506, thereby causing compression of the compressible layer 506.

Alternatively, the compressible layer 506 may extend beyond the footprint of the capsule body 534, in which case the compressible layer 506 may be compressed by a force applied to the top of the compressible layer 506 in a region beyond the footprint of the capsule body 534.

The compressible layer 506 shown in FIGS. 8 and 9 may be incorporated into the capsules shown in FIGS. 1 to 4. In this case, the relative movement of the puncturing elements towards the capsule may be provided partly by deformation of the capsule body, and partly by compression of a compressible layer. As an alternative to being included in the capsule, a compressible layer may instead be incorporated into the liquid handling devices 100, 500.

### Half-Teardrop Shaped Liquid Storage Portion

FIGS. 10A to 10C show a configuration of a capsule 620 that may be used for the capsules shown schematically in FIGS. 1 to 9. FIG. 10A is an isometric view of the capsule 620, FIG. 10B is a top view of the capsule 620, and FIG. 10C is a side view of the capsule 620.

As with the capsules shown in FIGS. 1 to 9, the capsule 620 comprises an inlet chamber 624, a liquid storage chamber 626, and an outlet chamber 628. The inlet chamber 624 is in fluidic communication with the liquid storage chamber 626 via a first restriction 630. The outlet chamber 628 is in fluidic communication with the liquid storage chamber 626 via a second restriction 632. The shape of the inlet chamber 624, liquid storage chamber 626 and outlet chamber 628 is defined by the capsule body 634. The capsule body 634 is sealed using a sealing layer 636.

As shown in FIGS. 10A to 10C, the inlet chamber 624 and the outlet chamber 628 each have a hemispherical shape. The liquid storage chamber 626 has a half-teardrop shape, where a half-teardrop shape should be taken to mean a teardrop divided in half along a plane parallel to and coincident with the longitudinal axis of the teardrop. The half-teardrop shape can be approximated by a half-cone shape (i.e. a cone divided in half along a plane running parallel to and coincident with its longitudinal axis) joined to a half-ellipsoidal shape (i.e. a half-ellipsoid (e.g. deformed hemisphere) divided in half along a plane running parallel to and coincident with its longitudinal axis) using a continuously smooth surface.

The half-teardrop shaped liquid storage chamber 626 has a bulbous portion 638 (approximated by the half-ellipsoidal shape) located at the first restriction 630, and an apex portion 640 (corresponding to the apex of the half-cone shape approximation) located at the second restriction 632. The apex portion 640 provides a taper between the bulbous portion 638 and the second restriction 632. Each of the bulbous portion 638 and the apex portion 640 has a concave surface.

The use of a half-teardrop shape for the liquid storage chamber 626 minimises the free surface of the liquid reagent within the liquid storage chamber 626 while maximising the volume of the liquid storage chamber 626 and maximising the tendency of the liquid reagent to remain in a homogeneous volume that amalgamates towards the second restriction 632 during release of the liquid reagent from the capsule 620 (in other words, minimising the tendency of the liquid reagent to fragment within the liquid storage chamber 626 during release of the reagent).

The first restriction 630 has a larger cross-sectional area than the second restriction 632. The larger cross-sectional area of the first restriction 630 is provided in order to allow air supplied via the opening in the inlet chamber 624 to flow up into the bulbous portion 638 of the liquid storage chamber 626.

The first restriction 630 is sized to minimise the flow of liquid reagent into the inlet chamber 624. Likewise, the second restriction 632 is sized to minimise the flow of liquid reagent into the outlet chamber 628. To minimise the flow of liquid reagent, the first and second restrictions 630, 632 are narrow enough that the surface tension of the liquid reagent prevents the liquid reagent from flowing through the restrictions 630, 632.

When the capsule 620 is filled with liquid reagent, the surface of the liquid reagent will protrude into the inlet chamber 624 and the outlet chamber 628, even in an ideal case. This is because the volume of liquid reagent within the liquid storage chamber 626 results in a pressure head which forces the liquid reagent partially into the inlet chamber 624 and the outlet chamber 628. When the capsule 620 is sealed, the inlet chamber 624 and outlet chamber 628 contain air, which is compressed by the liquid reagent that is forced into the inlet chamber 624 and outlet chamber 628 by the pressure head of the liquid reagent in the liquid storage chamber 626. The compression of the air within the inlet chamber 624 and the outlet chamber 628 applies a compressive force to the surface of the liquid reagent. This compressive force counteracts the force acting on the liquid reagent as a result of the pressure head of the liquid reagent in the liquid storage chamber 626. This results in the surface of the liquid reagent having a first equilibrium position located within the inlet chamber 624 slightly beyond the end of the first restriction 630 and a second equilibrium position located within the outlet chamber 628 slightly beyond the end of the second restriction 632, as shown in FIG. 10D.

In an ideal case, the surfaces of the liquid reagent do not extend as far as the locations in which the inlet chamber 624 and outlet chamber 628 are punctured (as shown in FIG. 10D). This means that the air supplied via the opening in the inlet chamber 624 (e.g. as described in relation to FIGS. 2 and 3) does not flow through a body of liquid reagent. This prevents the formation of microbubbles in the liquid reagent.

The bulbous portion 638 of the liquid storage chamber 626 ensures that the free surface of the liquid reagent is minimised, which reduces the tendency of the liquid reagent to fragment during release from the capsule 620. As shown in FIG. 10D, this minimised free surface results in a centroid 680 (shown in FIG. 10D) of the volume of liquid reagent within the liquid storage chamber 626 being biased towards the second restriction 632 (i.e. closer to the second restriction 632 than the first restriction 630).

The apex portion 640 of the liquid storage chamber 626 serves to minimise the free surface of the liquid reagent during release of the liquid reagent from the capsule 620. In particular, the apex portion 640 provides a taper of the liquid storage chamber 626 between the bulbous portion 638 and the second restriction 632, meaning that the free surface of the liquid reagent continuously reduces as liquid is released from the capsule 620. The continuous reduction in the free surface of the liquid reagent during release of the reagent encourages the liquid reagent within the liquid storage chamber 626 to remain in a homogenous volume that amalgamates towards the second restriction 632 as liquid reagent is released. This reduces the tendency of the liquid reagent within the liquid storage chamber 626 to fragment during release of the liquid reagent.

The shape of the liquid storage chamber 626 can be defined by an inlet angle 642 and an outlet angle 644. As shown schematically in FIG. 10C, the inlet angle 642 is the minimum angle between (i) a line that is located on the centreline (or plane of symmetry) of the liquid storage chamber 626 and is tangential to the surface of the bulbous portion 638 and (ii) the vertical (i.e. normal to the sealing layer 636 or the base of the capsule 620). Likewise, the outlet angle 644 is the minimum angle between (i) a line that is located on the centreline (or plane of symmetry) of the liquid storage chamber 626 and is tangential to the surface of the apex portion 640 and (ii) the vertical (i.e. normal to the sealing layer 636 or the base of the capsule 620).

The values of the inlet angle 642 and the outlet angle 644 are dependent on the type of liquid reagent within the capsule 620. That is, different values for the inlet angle 642 and the outlet angle 644 (and, consequently, different shapes for the liquid storage chamber 626) are used for different liquid reagents, in order to reduce the tendency of the liquid reagent to fragment during release of the reagent from the capsule 620.

The values used for the inlet angle 642 and the outlet angle 644 are dependent on the material used for the capsule body 634, the flow rate of air into the inlet chamber 634, and various characteristics of the liquid reagent, including surface tension, wettability and viscosity. For liquid reagents with a higher surface tension, the inlet angle 642 may be increased and the outlet angle 644 may be decreased (as explained further below).

As shown in FIGS. 10A to 10C, the capsule 620 comprises a base plate 650 that defines an aperture in the capsule body 634 (i.e. the aperture sealed by the sealing layer 636). The base plate 650 may be formed integrally with the capsule body 634. The base plate 650 provides a surface for attachment of the capsule 620 to a surface of a liquid handling device, or to a compressible layer of the capsule, as described above.

The tendency of a particular liquid reagent to fragment during release of the liquid reagent from the capsule 620 is shown in FIG. 10E, which also schematically shows the inlet angle 642 and the outlet angle 644. Referring back to FIG. 10D, it can be seen that the free surface of the liquid reagent is minimised prior to creation of the openings. As air is supplied via the opening in the inlet chamber 624, liquid reagent is pushed out of the liquid storage chamber 626 and into the outlet chamber 628. This increases the free surface of the liquid reagent within the liquid storage chamber 626. The increase of the free surface may result in the liquid reagent reaching an equilibrium position in which its free surface is minimised by fragmenting into two portions located at either side of the liquid storage chamber 626, as shown in FIG. 10E. When fragmentation occurs, air may be introduced into the liquid reagent that is forced out of the opening in the outlet chamber 628.

As explained above, the values of the inlet angle 642 and the outlet angle 644 may be adjusted to reduce the tendency of a particular liquid reagent to fragment. For example, to reduce fragmentation of the liquid reagent in the capsule 620 shown in FIG. 10E, the value of the inlet angle 642 may be increased and the value of the outlet angle 644 may be decreased, as shown in FIG. 10F. This results in a higher volume of the liquid reagent being released from the liquid storage chamber 626 prior to fragmentation of the liquid reagent. Consequently, the volume of the fragmented portions is reduced, meaning that a higher proportion of the liquid reagent within the capsule can be utilised.

### Different Half-Teardrop Shape for Different Reagent

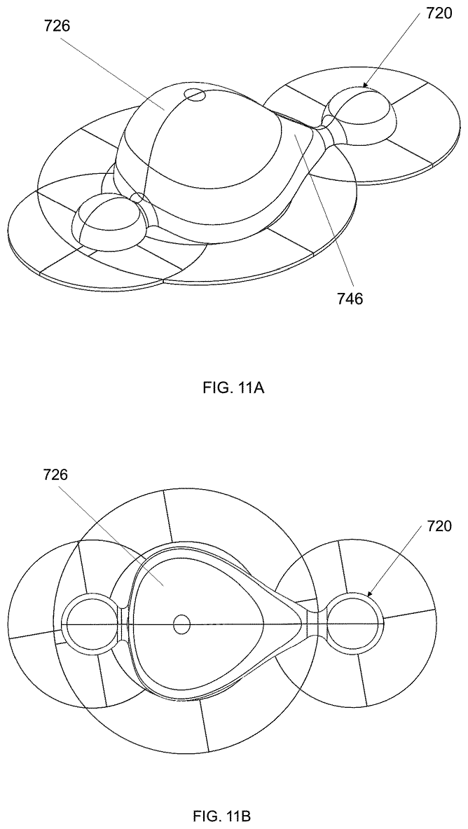

FIGS. 11A to 11C show an alternative capsule shape, which is used for a different liquid reagent to the liquid reagent used in the capsule 620 shown in FIGS. 10A to 10C. As shown in FIGS. 11A to 11C, the capsule 720 includes a liquid storage chamber 726 with an inlet angle 742 that is lower than the inlet angle 642 of the capsule 620, and with an outlet angle 744 that is higher than the outlet angle 644 of the capsule 620. This means that the curvatures of the curves that define the top of the bulbous portion 738 in FIGS. 11A to 11C are greater than (i.e. have lower curvature radii than) the curvatures of the curves defining the top of the bulbous portion 638 in FIGS. 10A to 10C. The capsule 720 shown in FIGS. 11A to 11C may be used for a liquid reagent with a lower surface tension than the liquid reagent used with the capsule 620.

As shown in FIGS. 11A to 11C, the capsule 720 may include one or more regions 746 with a convex curvature (i.e. in the apex portion 740 of the liquid storage chamber 726), in order to provide the continuous reduction in the free surface of the liquid reagent as the reagent is released from the capsule 720.

### Filleted Edge

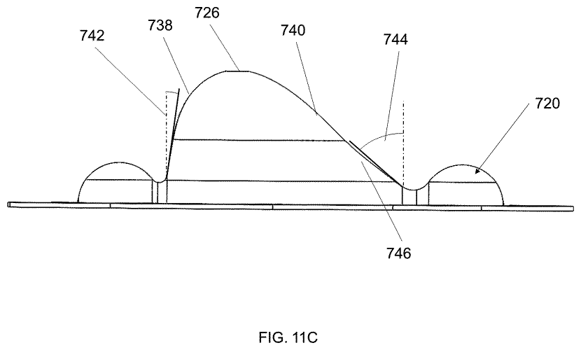

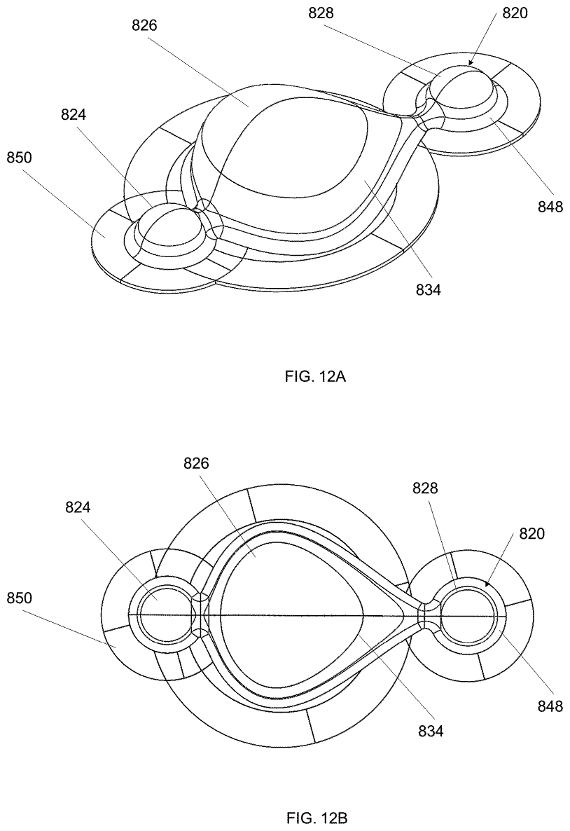

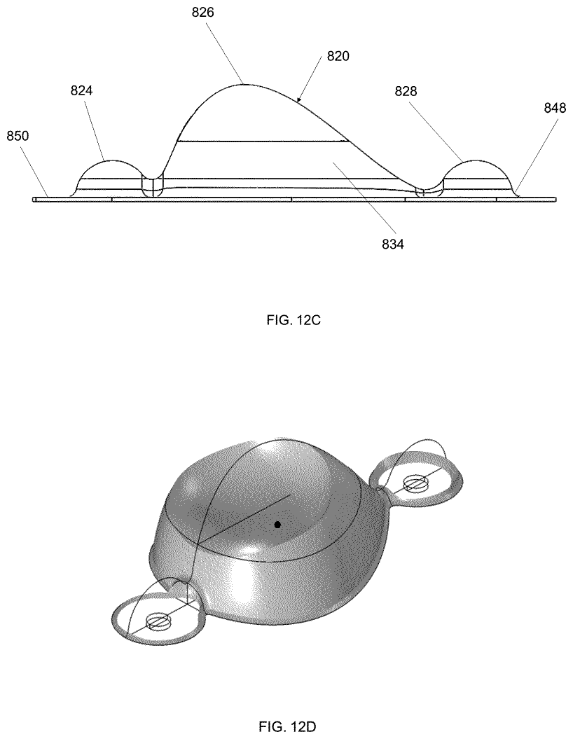

FIGS. 12A to 12C show a further alternative capsule shape, in which a capsule 820 comprises a capsule body 834 with a filleted edge 848. Specifically, the filleted edge 848 is provided at the join between the capsule body 834 and the base plate 850. The filleted edge 848 is therefore provided at the base of the inlet chamber 824, the liquid storage chamber 826 and the outlet chamber 828. Providing a filleted edge 848 between the capsule body 834 and the base plate 850 increases the ease of manufacture of the capsule 820 for manufacturing methods such as cold forming.

When a filleted edge 848 is provided, a portion of the liquid reagent is drawn into the inlet chamber 824 by capillary action and forms a ring around the edge of the inlet chamber 824 (as shown in FIG. 12D). In addition, a portion of the liquid reagent is drawn into the outlet chamber 828 by capillary action, thereby forming a ring around the edge of the outlet chamber 828. As shown in FIG. 12D, the liquid reagent drawn into the inlet chamber 824 and the outlet chamber 828 by capillary action does not extend as far as the locations in which the inlet chamber 824 and outlet chamber 828 are punctured. This means that the air supplied via the opening in the inlet chamber 824 (e.g. as described in relation to FIGS. 2 and 3) does not flow through a body of liquid reagent. This prevents the formation of microbubbles in the liquid reagent.

### Higher Draft Angle for Manufacture and Nipple Portion

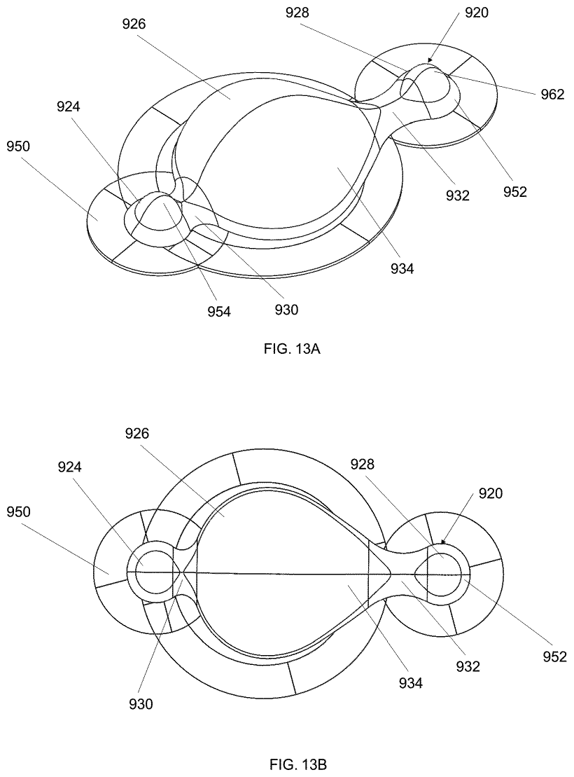

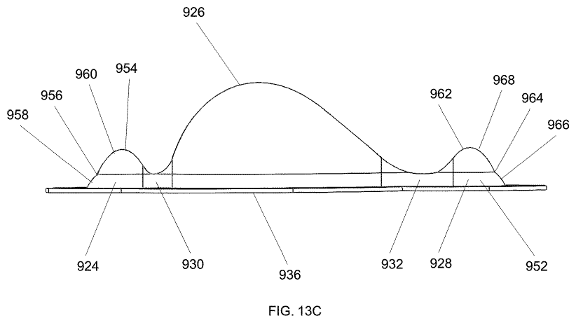

FIGS. 13A to 13C show a further alternative capsule shape, in which a capsule 920 comprises a capsule body 934 joined to a base plate 950 using a join 952 with a higher draft angle than the filleted edge 848 of the capsule 820 shown in FIGS. 12A to 12C. The higher draft angle join 952 increases the ease of manufacture of the capsule 920 for manufacturing methods (such as cold forming) that may be unable to provide the filleted edge 848 of the capsule 820.

When the join 952 with the higher draft angle is used, the volume of liquid reagent within an inlet chamber 924 and an outlet chamber 928 of the capsule 920 is higher than the volume of liquid reagent within the inlet chamber 824 and the outlet chamber 828 of the capsule 820 with the filleted edge 848. As a result, air supplied via the opening in the inlet chamber 924 may pass through a volume of liquid reagent, causing microbubbles to be formed in the liquid reagent.

To prevent the microbubbles in the liquid reagent in the inlet chamber 924 from passing into the liquid storage chamber 926, the inlet chamber 924 comprises a nipple portion 954. The nipple portion 954 is defined in the inlet chamber 924 by a step change 956 in curvature between the surfaces of the capsule body 934 that define the inlet chamber 924. The step change 956 in curvature provides a sharp edge that extends around the interior of the inlet chamber 924. This means that the inlet chamber 924 comprises a lower portion 958 at the base of the inlet chamber 924, which has a truncated dome shape with a concave surface; and an upper portion 960 having a dome shape with a concave surface, that provides the top surface of the inlet chamber 924 (which is also the top surface of the nipple portion 954). The upper portion 960 has a different curvature to the lower portion 958, which results in the step change 956 in curvature between the lower portion 958 and the upper portion 960. The upper portion 960 and lower portion 958 may alternatively be joined by a middle portion in which the surface of the inlet chamber 924 curves away from the interior of the inlet chamber 924 (instead of the sharp edge caused by the step change 956 in curvature).

As shown in FIGS. 13A to 13C, the step change 956 in curvature extends around the surface of the inlet chamber 924 above the height of the first restriction 930. This means that the first restriction 930 joins the liquid storage chamber 926 to the lower concave portion 958 of the inlet chamber 924.

The nipple portion 954 ensures that any microbubbles in the fluid in the inlet chamber 924 are trapped within the inlet chamber 924. Specifically, any microbubbles are trapped around the step change 956 in curvature when air is supplied via the opening in the inlet chamber 924. When the volume of liquid reagent within the inlet chamber 924 reduces (i.e. as the liquid reagent is released from the capsule 920), the microbubbles trapped within the inlet chamber 924 are retained around the periphery of the inlet chamber 924 at the base of the lower concave portion 958.

The ratio of the overall height of the inlet chamber 924 to the height of the step change 956 in curvature can be chosen to minimise microbubbles. This ratio will depend on the flow rate of the air being supplied via the opening in the inlet chamber 924 and, if the capsule 920 has been disrupted resulting in liquid reagent forming over the base of the inlet chamber 924, the characteristics of the liquid reagent. For example, for higher flow rates in a disrupted capsule, the step change 956 in curvature may be located higher up on the surface of the inlet chamber 924 (i.e. a lower ratio of the height of the inlet chamber 924 to the height to the step change 956 in curvature).

The outlet chamber 928 may also include a nipple portion 962 defined by a step change 964 in curvature extending around the surface of the capsule body 934 that defines the outlet chamber 928. In this case, the outlet chamber 928 also includes a lower portion 966, which has a truncated dome shape with a concave surface; and an upper portion 968 having a dome shape with a concave surface, that defines the top of the nipple portion 962 (i.e. the top of the outlet chamber 928). The upper portion 968 has a different curvature to the lower portion 966, which results in the step change 964 in curvature between the lower portion 966 and the upper portion 968. The upper portion 968 and lower portion 966 may alternatively be joined by a middle portion in which the surface of the outlet chamber 928 curves away from the interior of the outlet chamber 928 (instead of the sharp edge caused by the step change 964 in curvature). The step change 964 in curvature extends around the surface of the outlet chamber 928 above the height of the second restriction 932.

If the liquid reagent contains surfactants and/or other bubbling and/or foaming agents, then microbubbles may form on the surface of the liquid reagent in the liquid storage chamber 926 if the capsule 920 is knocked or otherwise disrupted. The nipple portion 962 of the outlet chamber 928 traps any microbubbles within the outlet chamber 928. Specifically, any microbubbles are trapped around the step change 964 in curvature when liquid reagent moves from the liquid storage chamber 926 to the outlet chamber 928. When the volume of liquid reagent within the outlet chamber 928 reduces (i.e. as the liquid reagent is released from the capsule 920), the microbubbles trapped within the outlet chamber 928 are retained around the periphery of the outlet chamber 928 at the base of the lower concave portion 966.

It will be appreciated that the nipple portions 954, 962 would have reduced effectiveness in a deformable capsule body, because the nipple portions 954, 962 would be crushed by the forces applied to the inlet chamber 924 and the outlet chamber 928. Preferably, therefore, the capsule 920 is used with a rigid capsule. For example, a sealing layer 936 of the capsule 920 may be attached to a compressible layer (e.g. as described with reference to FIG. 8 and FIG. 9).

Removing Liquid Reagent from Half-Teardrop Shaped Liquid Storage Chamber

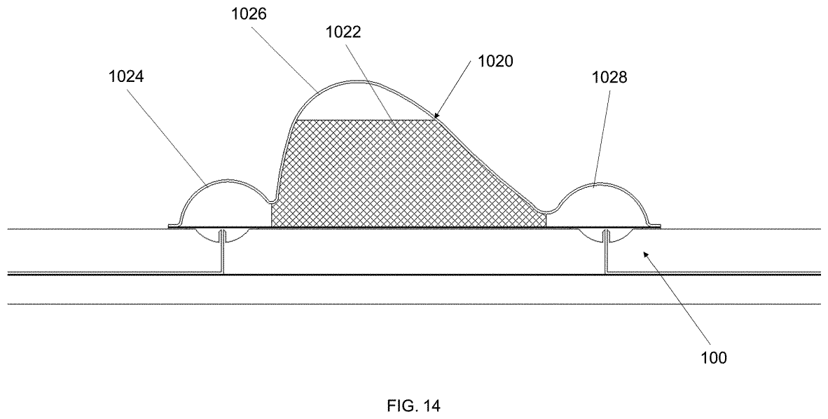

FIG. 14 is a schematic diagram of a capsule 1020 having a liquid storage chamber 1026 with a half-teardrop shape attached to the liquid handling device 100 shown in FIGS. 1 to 4. The capsule 1020 stores a liquid reagent 1022 which is retained mainly within the liquid storage portion 1026. As described in relation to FIGS. 1 to 4, the liquid handling device 100 comprises a capsule interface mechanism configured to create a first opening in an inlet chamber 1024 of the capsule 1020 and a second opening in an outlet chamber 1028 of the capsule 1020. The liquid reagent 1022 may be released from the capsule 1020 in the same way as described above in relation to FIGS. 1 to 4.

Alternatively, the capsule 1020 may further comprise a compressible layer (e.g. as described in relation to FIGS. 8 and 9). As a further alternative, the capsule 1020 may be attached to a liquid handling device that does not comprise puncturing elements (e.g. as described in relation to FIGS. 5 to 7), in which case the inlet chamber 1024 and outlet chamber 1028 of the capsule 1020 may comprise recesses (which may be filled), and preferably do not include a nipple portion.

### Alternative Liquid Storage Chamber Shapes

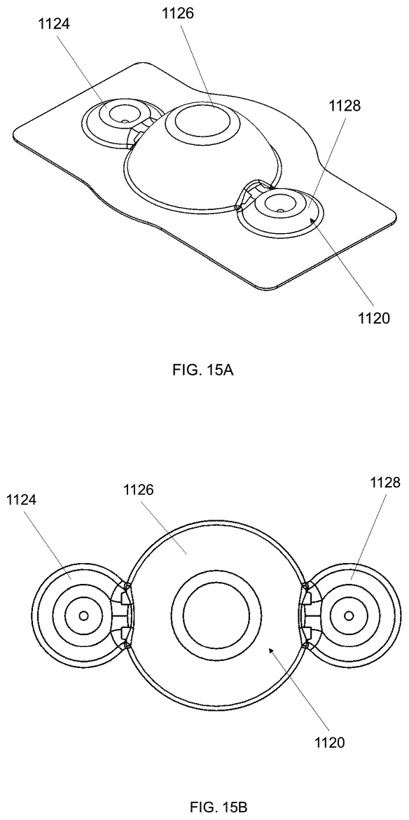

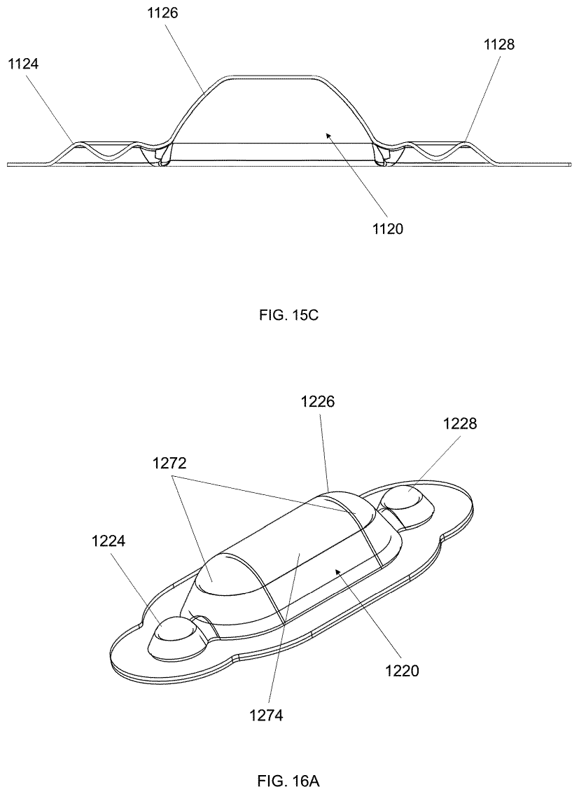

FIGS. 15A to 15C show an alternative capsule design in which a capsule 1120 comprises a liquid storage chamber 1126 having a flattened dome shape. The capsule 1120 can be used with any of the liquid handling devices described above. The capsule 1120 comprises an inlet chamber 1124 and an outlet chamber 1128. The inlet chamber 1124 and the outlet chamber 1128 are shown in FIGS. 15A to 15C as comprising recesses that allow the openings to be created in the capsule 1120. The inlet chamber 1124 and the outlet chamber 1128 may alternatively have a concave shape with features of the inlet and outlet chambers of the capsules described with reference to FIGS. 10A to 14.

The liquid storage chamber 1126 has a flattened dome shape. In a further alternative capsule design, the liquid storage chamber 1126 may have a rounded cone shape (or non-flattened dome shape) with its apex defining the height of the capsule. These shapes of liquid storage chamber 1126 may be easier to manufacture using cold forming as they require less material to be deformed to provide the final capsule shape. Accordingly, these shapes of liquid storage chamber 1126 may better correspond to the recommended draw ratio of 3:1 for a foil capsule (where the draw ratio is defined as the surface area of the formed foil divided by the surface area of the pre-formed foil).

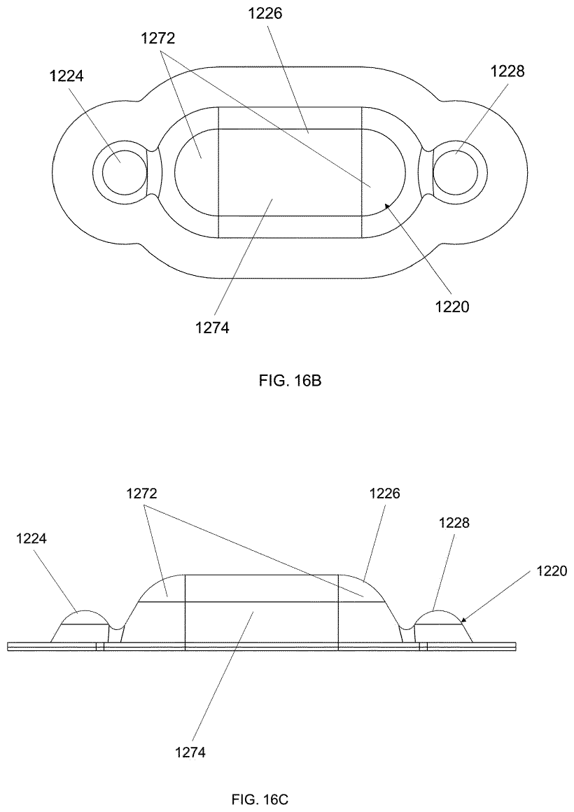

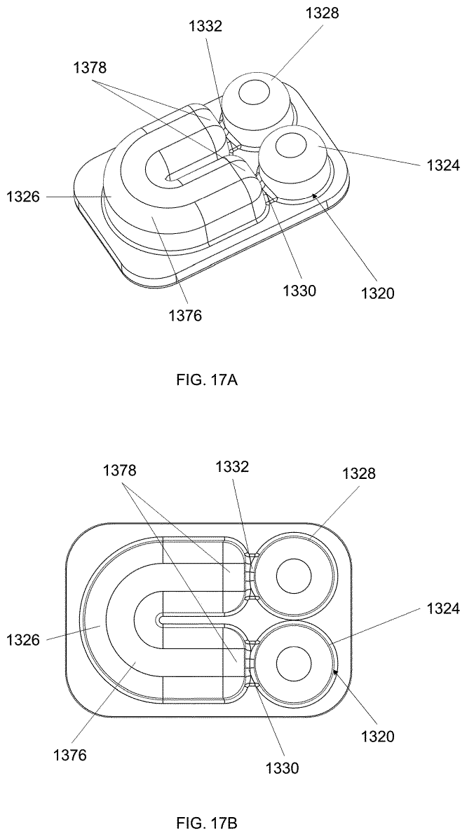

FIGS. 16A to 16C show a further alternative capsule design in which a capsule 1220 comprises a liquid storage chamber 1226 having an elongate shape. The capsule 1220 can be used with any of the liquid handling devices described above. The capsule 1220 comprises an inlet chamber 1224 and an outlet chamber 1228 that may comprise features of the inlet and outlet chambers of the capsules described with reference to FIGS. 10A to 14. The inlet and outlet chambers 1224, 1228 may alternatively include recesses (which may be filled), if the capsule 1220 is used with the liquid handling device 300 shown in FIGS. 5 to 7.

The liquid storage chamber 1226 of the capsule 1220 has an elongate shape. Specifically, the liquid storage chamber 1226 comprises a two half rounded cone shaped portions 1272 (with their apices defining the height of the capsule 120) separated by an elongate portion 1274 with a constant cross-section. Again, this shape of liquid storage chamber 1226 may be easier to manufacture using cold forming as it requires less material to be deformed to provide the final capsule shape.

FIGS. 17A and 17B show a further alternative capsule design in which a capsule 1320 comprises a U-shaped liquid storage chamber 1326 between an inlet chamber 1324 and an outlet chamber 1328 that are adjacent to each other. The capsule 1320 can be used with any of the liquid handling devices described above (although it will be appreciated that there would be reduced separation between the puncturing elements and/or depressions shown in FIGS. 1 to 9). The inlet chamber 1324 and the outlet chamber 1328 may comprise features of the inlet and outlet chambers of the capsules described with reference to FIGS. 10A to 14. The inlet and outlet chambers 1324, 1328 may alternatively include recesses (which may be filled), if the capsule 1320 is used with the liquid handling device 300 shown in FIGS. 5 to 7.

The liquid storage chamber 1326 of the capsule has a U-shaped portion 1376 with a constant cross-section. The liquid storage chamber 1326 also has rounded ends 1378 that join the U-shaped portion 1376 to the restrictions 1330, 1332. This geometry allows the inlet and outlet openings to be closer together than the other geometries. This means that it is easier for the two openings to be created in a single action (e.g. using a single actuator). The capsule 1320 is also a compact design that makes efficient use of the real estate available on a liquid handling device.

### Method of Removing Liquid Reagent

FIG. 18 is a flowchart of a method 1400 of removing liquid reagent from a capsule (e.g. a capsule as described in relation to the preceding figures). The method 1400 may be carried out using a liquid handling device (e.g. as shown in FIGS. 1 to 9) to which the capsule is attached, in combination with a liquid handling system in which a liquid handling apparatus (i.e. the liquid handling device and capsule) is received. In particular, the liquid handling system may comprise one or more actuatable elements configured to apply a force to one or more portions of the capsule attached to the liquid handling device or to the liquid handling device. The liquid handling system may also comprise a variable pressure source (e.g. a pump) configured to supply air via an air supply conduit (e.g. air supply conduit 70 shown in FIG. 3).

At 1402, a first opening in the capsule and a second opening in the capsule are created. As described above, the first and second openings may be created by relative movement of the capsule and a capsule interface mechanism. The relative movement may be provided by applying a force to one or more of the capsule and the liquid handling device using the liquid handling system. For example, a force may be applied by the liquid handling system to the capsule to deform the capsule. As another example, a force may be applied by the liquid handling system to the liquid handling device and/or the capsule to compress a compressible layer of the capsule.

At 1404, gas is supplied via the first opening in the capsule, in order to expel liquid reagent from the second opening in the capsule. Supplying the gas via the first opening may comprise coupling a gas supply port of the liquid handling device to a variable pressure source (e.g. a pump) configured to supply gas (e.g. air), and supplying gas from the variable pressure source to the first opening via a conduit of the liquid handling device that is in fluidic communication with the gas supply port and the first opening.

Once the liquid handling device has been inserted into the liquid handling system, the liquid handling system may be capable of carrying out the steps of the method 1400. The liquid handling system may also include software that allows it to carry out one or more fluidic operations on the liquid handling device. The software may also be configured to allow the liquid handling system to carry out the steps of the method 1400. Accordingly, the described method may be implemented using computer executable instructions. A computer program product or computer readable medium may comprise or store the computer executable instructions. The computer program product or computer readable medium may comprise a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). A computer program may comprise the computer executable instructions. The computer readable medium may be a tangible or non-transitory computer readable medium. The term “computer readable” encompasses “machine readable”.

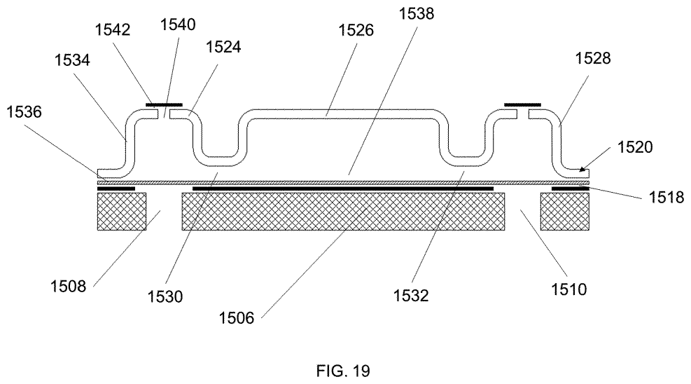

Capsule Construction FIG. 19 is a schematic diagram showing the construction of a capsule 1520 (e.g. the capsule shown in FIGS. 8 and 9). As shown in FIG. 19, the capsule 1520 comprises a capsule body 1534 comprising a first aperture 1538 and one or more second apertures 1540 (two second apertures are shown in FIG. 19). The capsule body 1534 defines an inlet chamber 1524 separated from a liquid storage chamber 1526 by a first restriction 1530, and an outlet chamber 1528 separated from the liquid storage chamber 1526 by a second restriction 1532. The first aperture 1538 extends across the base of the inlet chamber 1524, the liquid storage chamber 1526 and the outlet chamber 1528, as well as the regions in which the restrictions 1530, 1532 are located.

The area of the first aperture 1538 is larger than the area of the one or more second apertures 1540. For example, the total area of the one or more second apertures 1540 may be 50% less, preferably 90% less, or more preferably 95% less than the area of the first aperture 1538.

The capsule 1520 comprises first sealing layer 1536 configured to seal the first aperture 1538 and one or more second sealing layers 1542 each configured to seal a corresponding one of the one or more second apertures 1540 (two second sealing layers 1542 are shown in FIG. 19). Alternatively, one of the one or more second sealing layers may be configured to seal multiple second apertures. For example, a sealing layer in the form of a tape may seal second apertures that are adjacent to each other (e.g. if the capsule body 1334 in FIGS. 17A and 17B comprises an aperture in the top of each of the inlet and outlet chambers 1324, 1328).

In addition, the capsule 1520 comprises a compressible layer 1506 having a first passageway 1508 and a second passageway 1510. The compressible layer 1506 is attached to the first sealing layer 1536 using an adhesive layer 1518.

### Method of Constructing a Capsule

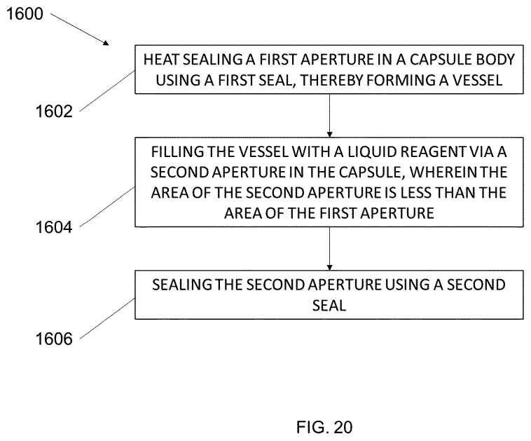

FIG. 20 is a flowchart of a method 1600 of constructing a capsule (e.g. the capsule 1520 shown in FIG. 19). That is, the capsule comprises a capsule body comprising a first aperture and one or more second apertures. As an example, the first aperture extends across a base of the capsule body, while the one or more second apertures are provided in a surface of the capsule body (e.g. an aperture in the top of the inlet chamber and/or the outlet chamber). Consequently, the area of the one or more second apertures is smaller than the area of the first aperture.

At 1602, the first aperture in the capsule body is heat sealed using a first seal. This process forms a vessel configured to hold a volume of liquid reagent.

At 1604, the vessel is filled with a liquid reagent via at least one of the one or more second apertures. Specifically, the vessel may be filled with a liquid reagent via a second aperture provided in the top surface of the inlet chamber. This allows the vessel to be filled with liquid reagent without the liquid reagent flowing into the outlet chamber, owing to the capillary stop provided by the restriction between the liquid storage chamber and the outlet chamber.

For example, the liquid reagent may be supplied into a first one of the one or more second apertures (e.g. in the inlet chamber), with other ones of the one or more second apertures (e.g. in the outlet chamber) used to vent air displaced from the capsule as it is filled with liquid reagent. Alternatively or additionally, the first one of the one or more second apertures (e.g. in the inlet chamber) may be large enough to accommodate the supply of liquid reagent and the venting of displaced air from the capsule (in which case, only one second aperture may be required).

At 1606, once the vessel has been filled with the desired volume of liquid reagent, the one or more second apertures may be sealed using a second seal. For example, the one or more second apertures may be sealed using one or more sealing layers that cover the one or more second apertures, and a pressure-sensitive adhesive between the sealing layer(s) and the capsule body.

By constructing a capsule using the method 1600 described above, the liquid reagent in the capsule is not exposed to a heat-sealing process. This is because heat-sealing of the capsule is carried out before the capsule is filled with the liquid reagent. Therefore, if the liquid reagent is sensitive to temperature changes, it is not exposed to a heat sealing process that causes the liquid reagent to be damaged.

Before sealing the one or more second apertures at 1606, air may be supplied via the first one of the one or more apertures (e.g. in the inlet chamber), in order to fill the inlet chamber with air and displace liquid reagent from the inlet chamber into the liquid storage chamber.

The method 1600 may be implemented as part of a computer-implemented manufacturing process. Accordingly, the described methods may be implemented using computer executable instructions. A computer program product or computer readable medium may comprise or store the computer executable instructions. The computer program product or computer readable medium may comprise a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). A computer program may comprise the computer executable instructions. The computer readable medium may be a tangible or non-transitory computer readable medium. The term “computer readable” encompasses “machine readable”.

Although the capsules in the examples described above include three chambers and first and second restrictions, capsules with a lower number of chambers may be used with the liquid handling devices and capsule interface mechanisms described above. If a lower number of chambers is used, the liquid reagent released from the capsule may be outlet to a chamber in fluidic communication with the second opening within the liquid handling device, prior to being transported to a particular location in the liquid handling device. This allows any bubbles in the liquid reagent to be vented out. Capsules with a lower number of chambers provide the advantages described above of releasing a greater proportion of the liquid reagent from the capsule (e.g. by supplying air via one opening in the capsule to expel liquid reagent from another opening in the capsule).

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

1. A liquid handling apparatus, comprising:
a capsule configured to store a liquid reagent;
a liquid handling device, comprising:
a first conduit in fluidic communication with a first port; and
a second conduit in fluidic communication with a second port; and
a capsule interface mechanism configured to create:
a first opening in the capsule in fluidic communication with the first port; and
a second opening in the capsule in fluidic communication with the second port;
wherein creating the first opening and the second opening allows the liquid reagent to be removed from the capsule.

2. A liquid handling apparatus according to claim 1, wherein the liquid handling device further comprises a gas supply port configured to receive gas supplied by a variable pressure source;
wherein the gas supply port is in fluidic communication with the first conduit; and
wherein the first conduit is configured to supply gas received via the gas supply port to the first opening to expel liquid reagent from the second opening after the first and second openings have been created.

3. A liquid handling apparatus according to claim 1 or claim 2, wherein the capsule interface mechanism is configured to create the second opening while creating the first opening.

4. A liquid handling apparatus according to any of claims 1 to 3, wherein the capsule interface mechanism is configured to create the first and second openings in the same side of the capsule.

5. A liquid handling apparatus according to any of claims 1 to 4, wherein the capsule interface mechanism is configured to create the second opening in a base of the capsule.

6. A liquid handling apparatus according to any of claims 1 to 5, wherein the capsule comprises a deformable material, wherein the capsule interface mechanism is configured to create the second opening in the capsule when the deformable material is deformed.

7. A liquid handling apparatus according to any of claims 1 to 6, wherein one or more of the capsule and the liquid handling device comprises a compressible layer configured to bias the capsule apart from the capsule interface mechanism;
wherein the capsule interface mechanism is configured to create the second opening in the capsule when the compressible layer is compressed.

8. A liquid handling apparatus according to claim 7, wherein the compressible layer comprises a passageway in fluidic communication with the second conduit, wherein the passageway is configured to permit the flow of liquid reagent from the second opening through the compressible layer.

9. A liquid handling apparatus according to any of claims 1 to 8, wherein the capsule interface mechanism comprises a puncturing element configured to puncture the capsule to create the second opening.

10. A liquid handling apparatus according to claim 9 when dependent on claim 8, wherein the puncturing element is disposed within the passageway.

11. A liquid handling apparatus according to any of claims 1 to 10, wherein the liquid handling device comprises the capsule interface mechanism.

12. A liquid handling device according to any of claims 1 to 11, wherein the capsule comprises:
a liquid storage chamber configured to store the liquid reagent;
an inlet chamber and an outlet chamber, wherein each of the inlet and outlet chambers is in fluidic communication with the liquid storage chamber;
a first restriction configured to prevent the flow of liquid between the liquid storage chamber and the outlet chamber prior to creation of the openings in the capsule; and
a second restriction configured to prevent the flow of liquid between the liquid storage chamber and the inlet chamber prior to creation of the openings in the capsule.

13. A liquid handling apparatus according to claim 12, wherein the capsule interface mechanism is configured to create the second opening in the outlet chamber.

14. A liquid handling apparatus according to claim 12 or claim 13, wherein the cross-sectional area of the first restriction is greater than or equal to the cross-sectional area of the second conduit.

15. A liquid handling apparatus according to any of claims 12 to 14, wherein the capsule interface mechanism is configured to create the first opening in the inlet chamber.

16. A liquid handling apparatus according to any of claims 12 to 15, wherein the outlet chamber comprises a recess in a surface of a capsule body that defines the outlet chamber.

17. A liquid handling apparatus according to claim 16, wherein the recess is filled with a rigid material.

18. A liquid handling apparatus according to claim 16 or claim 17, wherein the capsule comprises a sealing layer configured to seal an aperture in the capsule body;
wherein the interior surface of the recess is in contact with the sealing layer prior to creation of the openings in the capsule.

19. A liquid handling apparatus according to claim 18, wherein the interior surface of the recess is sealed to the sealing layer prior to creation of the openings in the capsule.

20. A liquid handling apparatus according to any of claims 12 to 19, wherein the liquid storage chamber has a half-teardrop shape having a bulbous portion adjacent to the first restriction and an apex portion that provides a taper between the bulbous portion and the second restriction.

21. A liquid handling apparatus according to claim 20, wherein:
the shape of the bulbous portion is defined by an inlet angle, wherein the inlet angle is the minimum angle between:
a first line that is located on the plane of symmetry of the liquid storage chamber and is tangential to the surface of the bulbous portion; and
a second line that is normal to the base of the capsule;
the shape of the apex portion is defined by an outlet angle, wherein the outlet angle is the minimum angle between:
a third line that is located on the plane of symmetry of the liquid storage chamber and is tangential to the surface of the apex portion; and
a fourth line that is normal to the base of the capsule; and
the outlet angle is larger than the inlet angle.

22. A liquid handling apparatus according to any of claims 12 to 21, wherein the outlet chamber comprises:
a lower portion having a truncated dome shape with a concave surface having a first curvature; and
an upper portion joined to the lower portion, wherein the upper portion has a dome shape with a concave surface having a second curvature different to the first curvature;
wherein the difference between the first curvature and the second curvature provides a step change in curvature at the join between the upper portion and the lower portion.

23. A liquid handling apparatus according to any of claims 1 to 22, wherein the capsule comprises:
a capsule body comprising a first aperture and a second aperture;
a first sealing layer configured to seal the first aperture and a second sealing layer configured to seal the second aperture;
wherein the area of the second aperture is less than the area of the first aperture.

24. A liquid handling apparatus according to claim 23, wherein the capsule interface mechanism is configured to create the first and second openings in the first sealing layer.

25. A method of removing liquid reagent stored in a capsule attached to a liquid handling device, the method comprising:
creating a first opening in the capsule and a second opening in the capsule; and
supplying gas via the first opening to expel liquid reagent from the second opening.

26. A method according to claim 25, wherein supplying the gas via the first opening comprises:
coupling a gas supply port of the liquid handling device to a variable pressure source configured to supply gas; and
supplying gas from the variable pressure source to the first opening via a conduit in fluidic communication with the gas supply port and the first opening.

27. A computer-readable medium comprising instructions that, when executed by a processor of a liquid handling system configured to receive a liquid handling apparatus, cause the liquid handling system to carry out the method of claim 25 or claim 26.

28. A method of manufacturing a liquid reagent capsule, the method comprising:
heat sealing a first aperture in a capsule body using a first seal, thereby forming a vessel;
filling the vessel with a liquid reagent via a second aperture in the capsule, wherein the area of the second aperture is less than the area of the first aperture; and
sealing the second aperture using a second seal.

29. A method according to claim 28, wherein the second aperture is sealed using a pressure-sensitive adhesive.
